(19) United States
(12) Patent Application Publication
(10) Pub. No.: US 2025/0299655 A1
(43) Pub. Date: Sep. 25, 2025

(54) GENERATING MUSICAL INSTRUMENT ACCOMPANIMENTS

(71) Applicant: RT Sixty Limited, Harrow (GB)

(72) Inventors: Edwin Robert TOULSON, London (GB); Michail EXARCHOS, London (GB); Isaac FARAZ-CHANDLER, London (GB)

(21) Appl. No.: 19/084,236

(22) Filed: Mar. 19, 2025

(30) Foreign Application Priority Data
Mar. 21, 2024 (GB) 2404064.4

(51) Int. Cl. G10H 1/00

(52) U.S. Cl. CPC G10H 1/0025; G10H 1/0033; G10H 2210/005; G10H 2210/076; G10H 2210/111

(57) ABSTRACT

A computer-implemented method of controlling a computing device to generate musical instrument accompaniments to accompany a reference musical instrument performance. Reference musical instrument performance data is obtained via a sensor of the computing device. The reference musical instrument performance data represents the reference musical instrument performance. A first musical instrument accompaniment to accompany the reference musical instrument performance is generated. The first musical instrument accompaniment is based on the reference musical instrument performance. A second musical instrument accompaniment to accompany the reference musical instrument performance is generated. The second musical instrument accompaniment is based on the first musical instrument accompaniment. Musical instrument accompaniment data representing the first and second musical instrument accompaniments is generated. The musical instrument accompaniment data is output via an output component of the computing device.

### CROSS-REFERENCE TO RELATED APPLICATIONS

This application claims priority to GB Application No. GB2404064.4, filed Mar. 21, 2024, under 35 U.S.C. § 119(a). The above-referenced patent application is incorporated by reference in its entirety.

### TECHNICAL FIELD

The present disclosure relates to generating musical instrument accompaniments.

### BACKGROUND

Musicians often have musical instrument knowledge in one musical domain but want to write music in another musical domain outside of their performance capability. For example, a guitarist might not be able to write music on a piano.

Automatic music composition products are known.

For example, in the context of bass guitar and bass musical instruments more generally, the Scalar 2 plugin from Plugin Boutique can generate basslines for a predetermined music score. In other words, Scalar 2 can generate a pattern of notes to be played by a bass guitar virtual musical instrument. A user can control the plugin to manipulate settings such as busyness and genre. Other similar products include, but are not limited to, Bassline Generator from Reason Studios, Unison Bass Dragon from Unison Audio, and EZbass from Toontrack.

There is very little, if any, artificial intelligence (AI) built into these tools. They are, instead, advanced arpeggiator devices, which play a pattern of sound that transposes to different chords. The results may therefore sound unnatural and may suit a limited range of music genres.

Reference is also made to: US2004089141 A1, which relates to systems and methods for creating, modifying, interacting with, and playing musical compositions; KR 2019 0100543 A, which relates to an electronic device and method for composing music based on an AI algorithm; and US2019035372 A1, which relates to a self-produced music server and system.

### SUMMARY

According to first embodiments, there is provided a computer-implemented method of controlling a computing device to generate musical instrument accompaniments to accompany a reference musical instrument performance, the method comprising: obtaining reference musical instrument performance data via a sensor of the computing device, the reference musical instrument performance data representing the reference musical instrument performance; generating a first musical instrument accompaniment to accompany the reference musical instrument performance, the first musical instrument accompaniment being based on the reference musical instrument performance; generating a second musical instrument accompaniment to accompany the reference musical instrument performance, the second musical instrument accompaniment being based on the first musical instrument accompaniment; generating musical instrument accompaniment data representing the first and second musical instrument accompaniments; and outputting the musical instrument accompaniment data via an output component of the computing device.

The computer-implemented method may be implemented solely by the computing device in that the computing device may perform the entire method. This differs from a method in which at least some actions are performed outside of the computing device by a different entity, such as a human and/or a remote server. By the computing device performing the entire method, data security may be improved and/or latency may be reduced. Data security improvement may be particularly effective in the context of musical instrument accompaniment generation, for example where the musical instrument accompaniment generation is for a demo recording of a song that is to be released at a later date. Latency reduction may also be particularly effective in the context of musical instrument accompaniment generation, for example where musical instrument accompaniments are played back in real time to accompany a real-time performance. High latency in such situations may result in unusable musical instrument accompaniments.

The reference musical instrument performance is used as a reference for the generation of the musical instrument accompaniments. This provides a constraint for the musical instrument accompaniments, which can result in more appropriate and symbiotic musical instrument accompaniments for a given musical instrument performance than where no reference performance is used.

The reference musical instrument performance data may be obtained via the sensor(s) in various ways. For example, the reference musical instrument performance data may be received via the sensor, may be captured via the sensor, or otherwise. The sensor may take various different forms depending, for example, on the nature of the computing device, the reference musical instrument performance, or otherwise.

As explained above, the first musical instrument accompaniment is based on the reference musical instrument performance. The first musical instrument accompaniment may additionally be based on one or more further factors in other examples. For example, the first musical instrument accompaniment may also be based on the second musical instrument accompaniment.

As also explained above, the second musical instrument accompaniment is based on the first musical instrument accompaniment. The second musical instrument accompaniment may additionally be based on one or more further factors in other examples. For example, the second musical instrument accompaniment may also be based on the reference musical instrument performance.

Generating the first and second musical instrument accompaniments can include tonal aspects, such as detailing sample pack choice, use of effects, etc.

The musical instrument accompaniment data may be output via the output component(s) in various different ways. For example, the musical instrument accompaniment data may comprise audio data, the output component may comprise a (built-in) loudspeaker, and the audio data may be played back to a user via the loudspeaker.

The above-described computer-implemented method provides various effects over known automatic music composition products.

For example, the computer-implemented method generates accompaniments to a musical instrument performance using the musical instrument performance as a reference. Compared to ‘isolated’ automatic music composition, more usable and symbiotic accompaniments may be generated. Such accompaniments may be more human-like, synchronised, compatible, musically interesting and/or viable than isolated compositions.

In addition, not only is a musical instrument performance used as a reference, one of the generated musical instrument accompaniments is used as a reference for another musical instrument accompaniment. This results in even more symbiotic and musically viable accompaniments, compared to accompaniments being independent of each other.

In some examples, the first musical instrument accompaniment is regenerated based on the second musical instrument accompaniment.

As explained above, the second musical instrument accompaniment is generated based on the first musical instrument accompaniment. However, a recursive loop and/or feedback loop may be used. For example, a second iteration of the first musical instrument accompaniment may be generated based on the second musical instrument accompaniment. This can result in more symbiotic musical instrument accompaniments, compared to there being no such iteration.

Such iteration of the first and/or second musical instrument accompaniments may continue. For example, the second musical instrument accompaniment may be regenerated based on the (regenerated) first musical instrument accompaniment, and so on.

Such iteration may be based on a triggering rule. For example, a bass instrument may follow a drum instrument and a keyboard instrument may follow the bass instrument. However, the keyboard instrument may also influence the drum instrument. A user may define and/or choose a triggering hierarchy in this manner.

Such iteration may cease in response to a trigger event. Example trigger events include, but are not limited to, a threshold number of iterations being made, a threshold iteration time being reached, predetermined user input, a desired result being reached, and so on. Human judgement may therefore stop the iterative process.

Different users may have different preferences on when an accompaniment is finished or is at least sufficient to be used. However, iterations such as those described above can be substantially instantaneous. In contrast, writing accompaniments and making modifications to them on paper, in a Musical Instrument Digital Interface (MIDI) editor, or with a band of musicians in a room would be a significantly slower way to evaluate all potential options and achieve a desired result.

In some examples, the first musical instrument accompaniment is regenerated based on one or more modifications made to the second musical instrument accompaniment.

In some examples, the second musical instrument accompaniment is regenerated based on one or more modifications made to the first musical instrument accompaniment.

While the first and/or second musical instrument accompaniment may be regenerated independent of, or even in the absence of, any modifications made to the other musical instrument accompaniment, factoring in the modification(s) better aligns the first and second musical instrument accompaniments with each other. This can result in more symbiotic computer-generated musical instrument accompaniments.

In some examples, the one or more modifications comprise a user-triggered modification.

In such examples, adaptations are responsive to the user. Modifications may, however, be more or fully autonomous in other examples.

In some examples, the second musical instrument accompaniment is based on the reference musical instrument performance.

As explained above, the first musical instrument accompaniment is based on the reference musical instrument performance and the second musical instrument accompaniment is based on the first musical instrument accompaniment. Therefore, the second musical instrument accompaniment is at least indirectly based on the reference musical instrument performance. However, the second musical instrument accompaniment can also be based directly on the reference musical instrument performance. This can better align the second musical instrument accompaniment with the reference musical instrument performance, compared to only an indirect link between the second musical instrument accompaniment and the reference musical instrument performance.

In some examples, the second musical instrument accompaniment is rhythmically correlated with the first musical instrument accompaniment.

In some examples, the first musical instrument accompaniment is rhythmically correlated with the second musical instrument accompaniment.

In some examples, the first and/or second musical instrument accompaniment is rhythmically correlated with the reference musical instrument performance.

This can result in more natural-sounding and symbiotic accompaniments, compared to there being no rhythmic correlation. For example, a kick drum and a bass instrument may be synchronised such that they are rhythmically locked together. In another example, the bass instrument may fill in the gaps between kick drum hits. In both examples, the kick drum and bass instrument may be rhythmically correlated, or rhythmically symbiotic. Rhythmically correlated bass instrument and kick drum accompaniments may sound more natural and authentic compared to bass instrument and kick drum accompaniments that are not rhythmically correlated.

Several further examples of rhythmic correlation will now be provided. In a first further example, a recording of a reference performance played on a guitar is analysed. The strumming pattern is used to define kick and snare drum timing and/or rhythm, and to define a dynamic variation of a drum kit accompaniment. The strumming pattern corresponds to the rhythmic and dynamic characteristics of the guitar reference performance. In a second further example, a drum kit reference performance is analysed. A bass guitar accompaniment is generated that rhythmically correlates with the kick drum pattern of the drum performance. The bass guitar accompaniment may also correlate with dynamics of the drum performance. The drum kit reference performance in the second further example may be the drum kit accompaniment generated in the first further example.

In some examples, the first and/or second musical instrument accompaniment is based on one or more musical properties of the reference musical instrument performance, wherein the one or more musical properties comprise harmony, melody and/or rhythm.

In some examples, the first musical instrument accompaniment is based on one or more musical properties of the second musical instrument performance, wherein the one or more musical properties comprise harmony, melody and/or rhythm.

In some examples, second musical instrument accompaniment is based on one or more musical properties of the first musical instrument performance, wherein the one or more musical properties comprise harmony, melody and/or rhythm.

This, again, can result in more symbiotic, natural and/or authentic accompaniments.

In some examples, the reference musical instrument performance data is analysed. For all or part of the reference musical instrument performance, and based on the analysing: one or more tempos are determined; one or more tempo changes are determined; one or more time signatures are determined; one or more time signature changes are determined; and/or one or more other temporal characteristics are determined.

Examples of such other temporal characteristics include, but are not limited to, swing, behind-beat and ahead-of-beat.

Knowledge of properties, such as these, of the reference musical instrument performance can assist in generating accompaniments that are an objectively strong musical match with the reference musical instrument performance.

In some examples, one or more spectrograms representing the reference musical instrument performance are generated. The one or more spectrograms may be analysed. The first and/or second musical instrument accompaniment may be based on the analysing of the one or more spectrograms. A spectrogram may be converted and/or filtered to represent a chromagram. A chromagram shows spectral power as musical notes changing with time. References herein to a spectrogram include a chromagram unless the context dictates otherwise.

This enables an objective analysis of the reference musical instrument performance to be made. As a result, accompaniments with objectively strong musical matches can be generated.

In addition, by generating and analysing a spectrogram, inferences can be made about the reference musical instrument performance automatically, without the user having to provide explicit user input defining the reference musical instrument performance. This can reduce accompaniment generation time, can reduce the impact of human errors (for example, where the user is a novice musician or is an advanced musician but one or more musical instruments are not their specialism), and so on.

In some examples, for all or part of the reference musical instrument performance, and based on the analysing of the one or more spectrograms: a performance structure is determined; a rhythm map of the reference musical instrument performance is determined; a musical key is determined; and/or a chord chart is determined.

Knowledge of such features can assist in generating musically symbiotic accompaniments. Although, a user may be able to input the information described above manually, automating determination of these features can save time and/or can reduce errors. Even technically proficient musicians might not be able to create these items perfectly accurately. Thus, these items may be created to a higher level of musical proficiency than the musician has themselves. For example, a musician may not be able to identify a complex chord in a harmonic progression, such as a half-diminished 7^{th} slash chord (for example, the chord Aₘᵢₙ7^{b5}/F#). Through the above-described automation, a musical performance may therefore be described in highly accurate musical terms and/or with better musical instrument knowledge than a human musician.

In some examples, the determining of the rhythm map is based on dynamic variations and/or spectral-temporal variations.

This provides a reliable and objective mechanism for automatically determining a rhythm map.

In some examples, generating the first and/or second musical instrument accompaniment comprises: selecting a subset of candidate musical patterns from a set of plausible musical patterns for the first and/or second musical instrument accompaniment. The selecting may be based on the reference musical instrument performance.

Such intelligent filtering can facilitate generation of musical instrument accompaniments with strong musical matches with the reference musical instrument performance. In addition, pre-sets and/or filtering may be guided by a target genre and/or musical characteristic.

In some examples, generating the first and/or second musical instrument accompaniment comprises: incorporating one or more humanizing transitions into the first and/or second musical instrument accompaniment; incorporating musical instrument context into the generating; incorporating musical context into the generating; and/or following one or more user-defined rules.

A humanizing transition gives a sense of human musicianship to a computer-generated accompaniment. This makes a computer-generated accompaniment sound more human-like and natural. A humanizing transition may also be referred to as a “musical” or “advanced” transition.

In some examples, the first musical instrument accompaniment is for a first musical instrument, the second musical instrument accompaniment is for a second musical instrument, and the first and second musical instruments are different from each other.

In some examples, the reference musical instrument performance is by a reference musical instrument, and the reference musical instrument is different from the first and second musical instruments.

This is particularly, but not exclusively, effective where a user has no or limited performance skills in the first and second musical instruments. Not only can musically accurate accompaniments be generated automatically, but accompaniments that also complement the reference musical instrument performance and each other.

In some examples, the musical instrument accompaniment data comprises: dynamic expression information; temporal information; timbral information; and/or spectral expression information.

This can facilitate generation of realistic-sounding musical instrument accompaniments.

In some examples, generating the musical instrument accompaniment data comprises synthesising the first and second musical instrument accompaniments into audible sound. The musical instrument accompaniment data may comprise audio data representing the audible sound.

The first and second musical instrument accompaniments may therefore be fully synthesised. The user does not need to possess or be able to play instruments associated with the first and second musical instrument accompaniments.

The accompaniments can be converted to audible sound in a number of ways. In a first example, short, pre-loaded sample waveforms for each musical note can be triggered from the musical instrument accompaniment data in real time, or the samples may be bounced to an offline audio file for future playback. This can reduce, or even avoid, the use of long audio phrases or loops. In a second example, the accompaniments may be converted to sound through a synthesizer algorithm. The synthesizer algorithm may use additive, subtractive, wavetable, frequency modulation (FM) or other sound synthesis techniques. A combination of both examples and/or other sound synthesis techniques may be used.

By synthesising in this manner, such audio can be created on-demand. This makes efficient use of the limited storage on mobile computing devices, for example compared to storing, in advance, audio of a large number of patterns on a large number of musical instruments.

According to second embodiments, there is provided a computer-implemented method, comprising: obtaining reference musical instrument performance data, the reference musical instrument performance data representing the reference musical instrument performance; determining one or more musical properties of the reference musical instrument performance based on analysing the reference musical instrument performance data; generating first musical instrument accompaniment data representing a first musical instrument accompaniment for the reference musical instrument performance, wherein the first musical instrument accompaniment is based on the reference musical instrument performance; generating second musical instrument accompaniment data representing a second musical instrument accompaniment for the reference musical instrument performance, wherein the second musical instrument accompaniment is based on: the determined one or more musical properties of the reference musical instrument performance; and one or more musical properties of the first musical instrument accompaniment; and outputting the first and second musical instrument accompaniment data.

At least some effects described above in relation to the first embodiments apply to the second embodiments.

In particular, in accordance with the second embodiments, one or more musical properties of the reference musical instrument performance are determined. Additionally, the second musical instrument accompaniment is based on: the determined one or more musical properties of the reference musical instrument performance; and one or more musical properties of the first musical instrument accompaniment. This provides strong musical symbiosis between the reference musical instrument performance and the first and second musical instrument accompaniments.

According to third embodiments, there is provided a computer-implemented method of controlling a computing device to generate a musical instrument accompaniment for reference musical instrument performances, the method comprising: obtaining first reference musical instrument performance data, the first reference musical instrument performance data representing a first reference musical instrument performance; obtaining second reference musical instrument performance data, the second reference musical instrument performance data representing a second reference musical instrument performance; generating a musical instrument accompaniment for the first and second reference musical instrument performances, wherein the musical instrument accompaniment is based on the first and second reference musical instrument performances represented by the obtained first and second reference musical instrument performance data; and outputting musical instrument accompaniment data representing the musical instrument accompaniment.

At least some effects described above in relation to the first and second embodiments apply to the third embodiments.

In relation to the third embodiments, multiple reference musical instrument performances are used to generate a musical instrument accompaniment. The reference musical instrument performances may be human performances, computer-generated performances, or a combination of human and computer-generated performances.

According to fourth embodiments, there is provided a computing device comprising: a sensor; an output component; and a controller configured to perform a method according to any of the first through third embodiments.

In some examples, the sensor is a built-in microphone.

In some examples, the output component is: a built-in loudspeaker; or a radio frequency (RF) transmitter.

Leveraging a built-in component of the computing device may remove, or at least reduce, the need for additional hardware components.

In some examples, the computing device is a smartphone or a tablet computer.

Such computing devices may be readily available to a user and may be leveraged to perform techniques described herein. This can remove, or at least reduce, the need for additional hardware.

According to fifth embodiments, there is provided a computer program configured to perform a method according to any of the first through third embodiments.

According to sixth embodiments, there is provided musical instrument accompaniment data obtained by a method according to any of the first through third embodiments.

### BRIEF DESCRIPTION OF THE DRAWINGS

FIG. 1 shows a schematic representation of an example of a system in which one or more musical instrument accompaniments can be generated;

FIG. 2 shows a schematic representation of an example of the musical analysis engine shown in FIG. 1;

FIG. 3 shows an example of a graphical user interface (GUI) representing example user input data;

FIG. 4 shows another example of a GUI representing an example song structure chart;

FIG. 5 shows an example of a chart corresponding to an example rhythm map;

FIG. 6 shows an example of a chart corresponding to an example high-resolution chromagram;

FIG. 7 shows an example of a chart corresponding to an example cleaned chromagram and an example of a chart corresponding to an example chart;

FIG. 8 shows an example of a chart corresponding to another example chart;

FIG. 9 shows another example of a GUI representing an example chord chart;

FIG. 10 shows a set of example GUIs collectively representing an example musical analysis implementation;

FIG. 11 shows a schematic representation of an example of the algorithmic orchestration engine shown in FIG. 1;

FIG. 12 shows a schematic representation of an example of a sub-system of the example system shown in FIG. 1, the example sub-system comprising the performance engine system and the music production platform shown in FIG. 1;

FIG. 13 shows another example of a GUI representing an example musical instrument accompaniment;

FIG. 14 shows another example of a GUI representing modification options for the example musical instrument accompaniment shown in FIG. 13;

FIG. 15 shows another example of a GUI representing another example musical instrument accompaniment;

FIG. 16 shows another example of a GUI representing modification options for the example musical instrument accompaniment shown in FIG. 15;

FIG. 17 shows another example of a GUI representing another example musical instrument accompaniment;

FIG. 18 shows another example of a GUI representing modification options for the example musical instrument accompaniment shown in FIG. 17;

FIG. 19 shows a schematic representation of an example of a computing device in which musical instrument accompaniments can be generated;

FIG. 20 shows a flowchart representing an example of a method in which musical instrument accompaniments can be generated;

FIG. 21 shows a flowchart representing another example of a method in which musical instrument accompaniments can be generated;

FIG. 22 shows a flowchart representing another example of a method in which musical instrument accompaniments can be generated; and

FIG. 23 shows a flowchart representing another example of a method in which one or more musical instrument accompaniments can be generated.

### DETAILED DESCRIPTION

### Introduction

In general terms, the present disclosure provides an intelligent musical instrument accompaniment generator.

The musical instrument accompaniment generator may provide assisted and/or automated composition. Such composition may accompany pre-recorded music, music being performed in real-time and/or a predefined music score. The accompaniment may accompany one or more reference performances from one or more performers made using one or more musical instruments. The accompaniment(s) may be for one or more accompanying musical instruments. A musician may therefore perform on one musical instrument and have intelligently generated accompaniments on a number of other musical instruments, which the musician might not be able to play themselves.

Automated accompaniment composition is a specific type of automated composition, where music is composed to be a supporting or accompanying musical instrument to music and/or musical score that already exists. A musical accompaniment fits and/or compliments music that is to be accompanied.

Generating musical instrument accompaniments in this manner can save a significant amount of time compared to manual accompaniment generation, even for a musician that is proficient on a range of musical instruments.

For example, techniques described herein can take a three-minute rhythm guitar performance as input, and output a three-piece accompaniment (piano, bass and drums) in a matter of seconds. Playing and recording acceptable takes of those three accompaniments would take a proficient musician at least ten minutes (allowing three minutes to perform each accompaniment) and would take a less proficient musician considerably longer if they could even perform the accompaniments at all.

Further, in accordance with examples described herein, a musician can access accompaniments that are beyond their own proficiency level in accompanying musical instruments they can play, but only at a basic level.

Examples described herein can help musicians complete unfinished songs, which the musician has started but has not been able to complete themselves. Unfinished songs can take up a significant amount of storage space on a computing device. In particular, a musician might record one part of a song in a digital audio workstation (DAW) using only one musical instrument, creating a DAW project file in the process. DAW project files can be relatively large in size, for example compared to a single uncompressed, lossless, pulse-code modulation (PCM) audio file, such as a Waveform Audio File Format (WAV) file. However, an artist may be reluctant to delete a DAW project file for an unfinished song until the song has been completed. By completing an unfinished song using the example techniques described herein, storage space can potentially be freed up.

Examples described herein allow a musician to use their musical knowledge across all musical instruments to create layered compositions. Such compositions may be layered in that they are multi-track, multi-musical-instrument compositions. Such compositions may be used as demo recordings, for release, or otherwise.

Examples described herein enable one or multiple musical instrument recordings to be evaluated, and a number of accompanying musical instrument sounds to be generated based on the evaluating.

Examples described herein can be particularly effective when performed by mobile platforms on mobile computing devices, such as smartphones, tablet computers, and laptop computers.

Battery usage can be particularly relevant in such devices. Generating a song with intelligent accompaniments to a given reference track can use less battery than recording human-performed accompaniments to the given reference track.

Many physical (i.e. non-virtual) musical instruments consume electrical power to generate sound so that they can be recorded. Computer-generated accompaniments as described herein can use less energy than that for powering physical musical instruments for recording. Energy associated with recording such instruments using a recording system may also be reduced or avoided. Such energy may, for example, be for powered microphones, interfaces, preamplifiers, etc.

Computer-generated musical instrument accompaniments as described herein may be created within an existing computing device, such as a smartphone. This may avoid the need for specialist recording hardware, such as specialist microphones, audio interfaces, microphone preamplifiers, etc.

Mobile computing devices are highly portable and are often carried by a user. They are generally readily available whenever the user wishes to record a reference performance.

A mobile computing device having a touchscreen interface can provide tactile user interaction.

Where machine learning (ML) models are stored on the computing device, and the techniques described herein are performed on the computing device, data security may be enhanced relative to client-server architectures. For example, data may not be sent over a public network, such as the Internet, to a remote server for processing. This may be especially effective for as-yet-unreleased music.

Where the techniques described herein are performed on the computing device, the computing device may not need a network connection to be able to generate the musical instrument accompaniments. This can be particularly effective in environments such as music rehearsal rooms, which may not have a strong cellular and/or Wi-Fi signal. This may also reduce cost where broadband Wi-Fi is not available and where there is a cost to use another type of network connection.

On-device generation may provide lower latency than server-based generation. This may be particularly effective in latency-critical scenarios, such as real-time accompaniment.

### Definitions

Various terms used herein will now be described.

The term “composition” is generally used herein to mean a collection of musical instrument accompaniments or individual musical instrument scores or parts for multiple musical instruments. A composition may also be referred to as a “score”.

The term “musical score” is generally used herein to mean a notation of harmony, melody and rhythm information.

The term “harmony” is generally used herein to mean a progression of concurrent notes and pitches over a musical passage.

The term “melody” is generally used herein to mean a monophonic series of consecutive notes, where each note has a pitch and duration.

The term “rhythm” is generally used herein to mean the temporal and dynamic organisation of musical events.

The term “orchestration” is generally used herein to mean the combination of composition and performance instructions for one or more musical instruments.

The term “accompaniment” is generally used herein to mean music that compliments, and that is in symbiosis with, reference music that it accompanies.

The term “musical instrument” is generally used herein to mean any instrument that can create music, including the human voice.

The terms “instrument context” and “musical instrument context” are generally used herein to mean the bounds of a musical instrument and the way in which a proficient musician might play the musical instrument. For example, a violin cannot play effectively below a certain register. Equally, a bass guitar tends to be played in a monophonic manner.

The term “musical context” is generally used herein to mean an accompaniment obeying defined musical rules of harmony, melody and rhythm. Examples include, but are not limited to, handling chords and accidental notes that are technically out-of-key, and playing different registers in different song sections to stipulate or accentuate structural changes in an arrangement, for example when moving from a verse to a chorus.

The term “sidechain” is generally used herein to mean data from a first component that is passed to, and/or is otherwise available to, a second component to influence the action and/or functionality of the second component.

The term “sub-division” is generally used herein to mean a measure of time within a musical beat. For example, a bar may have four beats, each of which is split into four sub-divisions. In this case, the bar has sixteen sub-divisions. Such sub-divisions may be referred to as sixteenths or semiquavers.

### Musical Instrument Accompaniment Generation System 100

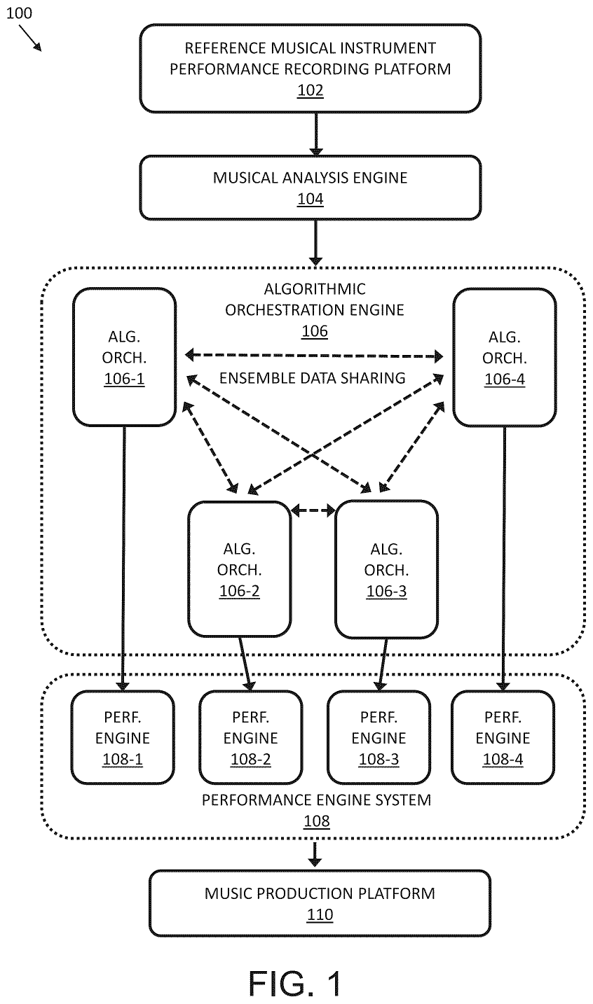

Referring to FIG. 1, there is shown an example system 100 in which techniques described herein may be performed. In particular, the example system 100 may be configured to implement one or more methods, such as controlling a computing device to generate one or more musical instrument accompaniments to accompany one or more reference musical instrument performances.

Techniques described herein may be performed in different systems in other examples. Various components of the example system 100 are shown in FIG. 1. Such components may be embodied in hardware and/or software.

The example system 100 comprises a reference musical instrument performance recording platform 102.

A user of the system 100 uses the reference musical instrument performance recording platform 102 to record a reference musical instrument performance.

The user may be referred to as a “musician”, “performer” or the like. The user may, however, have any level of musical proficiency.

The reference musical instrument performance may be referred to herein as a “performance”, “musical performance”, “music performance” or the like. The reference musical instrument performance may or may not be performed in front of an audience. The reference musical instrument performance is a reference performance in that it is used as a reference for computer-generated accompaniments, as will be described in more detail below.

The user may record the reference musical instrument performance in various different ways. For example, the user may select an option to start recording and select another option to stop recording when they have completed the reference musical instrument performance. The user may select a metronome click and/or another type of backing track to record along to.

The recording of the reference musical instrument performance results in reference musical instrument performance data. The reference musical instrument performance data may comprise audio data representing the reference musical instrument performance. The audio data may be a WAV file or may be in another format.

The recording itself may be captured in various different ways. For example, the recording may be captured by a sensor in the form of a microphone. The microphone may be a built-in microphone. A built-in microphone may also be referred to as an “integral microphone”, an “integrated microphone”, or the like. In another example, the microphone is not built in.

The example system 100 comprises a musical analysis engine 104. The musical analysis engine 104 performs musical analysis of the recording of the musical performance. In the example system 100, the musical analysis engine 104 has, as input, an output of the user performance recording platform 102.

The example system 100 comprises an algorithmic orchestration engine 106. The algorithmic orchestration engine 106 orchestrates generation of musical instrument accompaniments algorithmically. In the example system 100, the algorithmic orchestration engine 106 has, as input, an output of the musical analysis engine 104.

In this example, the algorithmic orchestration engine 106 comprises first through fourth algorithmic orchestration components 106-1, 106-2, 106-3, 106-4. However, the algorithmic orchestration engine 106 can comprise a different number of algorithmic orchestration components in other examples.

Each algorithmic orchestration component 106-1, 106-2, 106-3, 106-4 can have a given musical function and/or can use a given virtual musical instrument. In this specific example, the first algorithmic orchestration component 106-1 has a beat function and uses a rock drum kit virtual musical instrument, the second algorithmic orchestration component 106-2 has a bass function and uses an analogue synthesiser virtual musical instrument, the third algorithmic orchestration component 106-3 has a rhythm function and uses a piano virtual musical instrument, and the fourth algorithmic orchestration component 106-4 has a pads function and uses a strings virtual musical instrument. Different functions and/or virtual musical instruments may be used in other examples.

In general, the algorithmic orchestration engine 106 generates a first musical instrument accompaniment to accompany a reference musical instrument performance. The first musical instrument accompaniment is based on the reference musical instrument performance. Additionally, the algorithmic orchestration engine 106 generates a second musical instrument accompaniment to accompany the reference musical instrument performance. The second musical instrument accompaniment is based on the first musical instrument accompaniment.

The first musical instrument accompaniment may be for a first musical instrument, the second musical instrument accompaniment may be for a second musical instrument, and the first and second musical instruments may be different from each other. The reference musical instrument performance may be by a reference musical instrument, and the reference musical instrument may be different from the first and second musical instruments.

The example system 100 comprises a performance engine system 108. The performance engine system 108 generates performance data representing the accompaniments. In the example system 100, the performance engine system 108 has, as input, an output of the algorithmic orchestration engine 106.

In this example, the performance engine system 108 comprises first through fourth performance engine components 108-1, 108-2, 108-3, 108-4. In this specific example, the first through fourth performance engine components 108-1, 108-2, 108-3, 108-4 have, as inputs, outputs of the first through fourth algorithmic orchestration components 106-1, 106-2, 106-3, 106-4 respectively.

The performance data generated by the performance engine system 108 is an example of musical instrument accompaniment data representing one or more musical instrument accompaniments.

The example system 100 comprises a music production platform 110. In the example system 100, the music production platform 110 has, as input, an output of the performance engine system 108. The music production platform 110 may be used to perform various different music production functions. Examples of such music production functions include, but are not limited to, multi-track overdubbing, mixing, playback and exporting. An output of the music production platform 110 is another example of musical instrument accompaniment data as described herein.

### Musical Analysis Engine 104

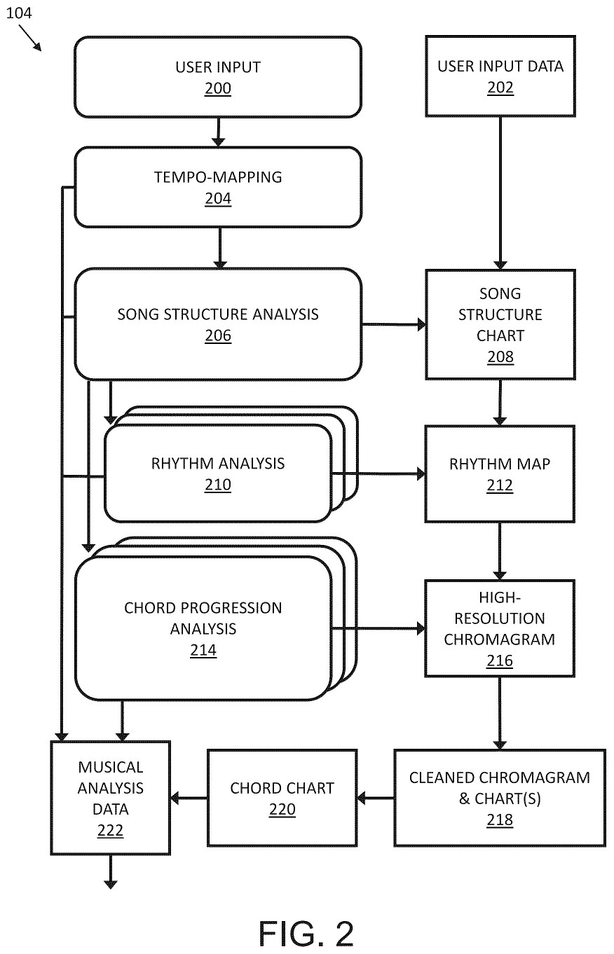

Referring to FIG. 2, there is shown an example of a musical analysis engine 104. In this example, the musical analysis engine 104 is the musical analysis engine 104 described above with reference to FIG. 1.

The example musical analysis engine 104 comprises a user input component 200. The user can input data via the user input component 200. In this example, the user input component 200 obtains user input data 202.

The user input component 200 enables the user to record one or more music performances. A music performance may be performed on any musical instrument. Examples of such musical instruments include, but are not limited to, guitar, piano, drums and voice.

The user input component 200 may enable the user to select a tempo and/or time signature of a performance. A tempo may also be referred to as a “BPM”, which stands for beats per minute.

The user input component 200 may enable the user to select one or more playback tracks for playback. Examples of playback tracks include, but are not limited to, a drum pattern, a prior recording, a repeating loop, and a MIDI pattern.

If the user has set a tempo, the user may listen to a click track and/or drumbeat such that the click track and/or drumbeat is not audible in a recording of their reference performance. The user may, for example, listen to the click track and/or drumbeat playback on headphones while the recording of their reference performance is captured via a microphone.

Thus, the user input component 200 enables the example system 100 to obtain reference musical instrument performance data via a sensor of a computing device, where the reference musical instrument performance data represents one or more reference musical instrument performances.

The example musical analysis engine 104 comprises a tempo-mapping component 204. The tempo-mapping component 204 may determine a tempo, a tempo change, a time signature, a time signature change, and/or a temporal characteristic of a performance. In the example musical analysis engine 104, the tempo-mapping component 204 has, as input, an output of the user input component 200.

If the user has not set a tempo using the user input component 200, the tempo-mapping component 204 may use a tempo-mapping algorithm to determine the tempo of the music performance. The tempo-mapping component 204 may, alternatively or additionally, determine a time signature of the music performance.

The tempo-mapping component 204 may fit the music performance to a time grid of bars and beats. Recorded audio may be digitally quantized to a fixed grid, or the grid may be left unquantized.

The example musical analysis engine 104 comprises a song structure analysis component 206. In the example musical analysis engine 104, the song structure analysis component 206 has, as input, an output of the tempo-mapping component 204. The song structure analysis component 206 may generate a song structure chart 208. The song structure analysis component 206 may use a song structure analysis algorithm to generate the song structure chart 208. Song structure may also be referred to as an “arrangement”. References herein to a “song” encompass both complete songs and part-complete songs. For example, a musical performance on a single musical instrument may be considered to be a song, even if there is an intention to add additional musical instrument accompaniments to the single-musical-instrument performance.

The song structure analysis component 206 may convert the recording of the song to a chromagram. The song structure analysis component 206 may analyse the chromagram. The song structure analysis component 206 may identify recurrent chromagram patterns in the chromagram. The song structure analysis component 206 may deduce the song structure based on the identified recurrent chromagram patterns.

Although specific examples described herein concern chromagrams, such examples are equally applicable to spectrograms. A chromagram is a filtered and/or quantized spectrogram.

The song may, hence, be described in terms of sections, which may also be referred to as “segments”. Bar and/or beat lengths may be identified for each section. Unique and repeating sections may be identified. Such sections and may be named automatically, for example as “verse”, “chorus”, “bridge”, “musical instrumental” and so on. Such automatic naming may use a machine learning (ML)-trained algorithm. Alternatively or additionally, the user may name the sections using their own preferred terms after analysis completes. For example, the user may name the sections “A”, “B” and “C” and the song structure may be provided as “A”, “B”, “C”, “B”, “C”, “A”. Identification of repeating sections may be useful even if the sections are not named automatically and/or are not named in song structure terms.

The example musical analysis engine 104 comprises a rhythm analysis component 210. In the example musical analysis engine 104, the rhythm analysis component 210 has, as input, an output of the song structure analysis component 206. The rhythm analysis component 210 may generate one or more rhythm maps 212. The rhythm analysis component 210 may use a rhythm analysis algorithm to generate the rhythm map(s) 212. A rhythm map may be referred to herein as a “rhythm chart”.

The rhythm analysis component 210 may evaluate the song. The example rhythm analysis component 210 may generate a rhythm map 212 for each segment of the song.

The example rhythm analysis component 210 deduces a dynamic power and/or a spectral power of the performance for each rhythmic sub-division of the segment. The rhythmic sub-division may be a sixteenth of a bar, and a segment may have multiple bars. The rhythmic sub-division is a musical division or sub-division.

The example musical analysis engine 104 comprises a chord progression analysis component 214. In the example musical analysis engine 104, the chord progression analysis component 214 has, as input, an output of the song structure analysis component 206. The chord progression analysis component 214 may use a chord progression analysis algorithm.

The song structure analysis component 206 may generate a high-resolution chromagram 216, a cleaned chromagram and one or more charts 218, and a chord chart 220. The one or more charts 218 may comprise a chord identification chart and/or a chord onset chart. A chord identification chart identifies chords. A chord onset chart defines the onset of chords or chordal change points. This maps to the chord chart 220, which is in a standard format that a session musician would expect to see in a professional setting.

The chord progression analysis component 214 may perform various actions for each song segment (for example, verse, chorus, etc).

Firstly, the chord progression analysis component 214 may convert the segment into the high-resolution chromagram 216.

Secondly, the chord progression analysis component 214 may analyse the high-resolution chromagram 216. The chord progression analysis component 214 may analyse the high-resolution chromagram 216 by evaluating the high-resolution chromagram 216 with a neural network or otherwise. Based on the evaluation, the chord progression analysis component 214 may deduce the musical key of the segment.

Thirdly, the chord progression analysis component 214 may evaluate the high-resolution chromagram 216 and the deduced musical key. This may involve a neural network or otherwise. For example, a direct comparison and least error calculation may be used with reference to benchmark chroma and/or key profiles.

The example chord progression analysis component 214 identifies a chord for each sub-division for the segment.

The example chord progression analysis component 214 evaluates the rhythm map 212 and the chord chart, with a neural network or otherwise. For example, the rhythm map 212 may be evaluated using algorithmic dynamics and/or power analysis. Based on the evaluation, the example chord progression analysis component 214 identifies a position of chord changes and/or onsets, and identifies a repeatable chord pattern length.

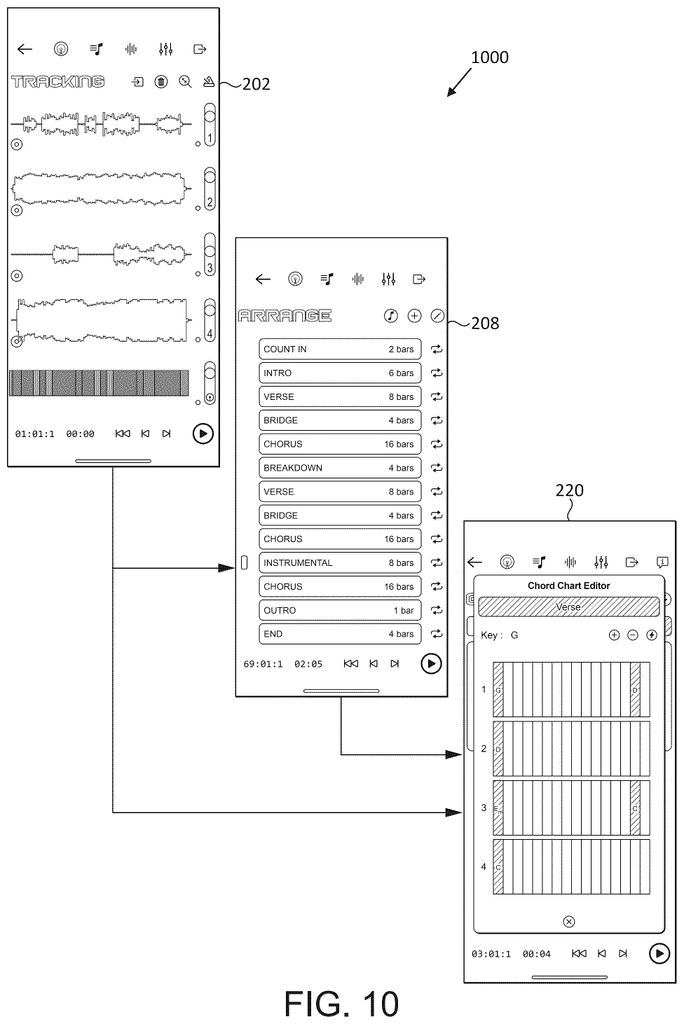

In this example, the example musical analysis engine 104 produces musical analysis data 222. In this example, the musical analysis data 222 comprises data from the tempo-mapping component 204, the song structure analysis component 206, the rhythm analysis component 210 and the chord progression analysis component 214. In this example, the musical analysis engine 104 provides the musical analysis data 222 to the algorithmic orchestration engine 106 described above with reference to FIG. 1 and below with reference to FIG. 10.

Thus, the example musical analysis engine 104 may analyse reference musical instrument performance data. The example musical analysis engine 104 may, based on the analysing, and for all or part of the reference musical instrument performance, determine one or more tempos, determine one or more tempo changes, determine one or more time signatures, determine one or more time signature changes, and/or determine one or more other temporal characteristics.

The example musical analysis engine 104 may generate one or more spectrograms (for example, chromagrams) representing one or more reference musical instrument performances and may analyse the one or more spectrograms. First and/or second musical instrument accompaniments may be generated based on the analysing of the one or more spectrograms.

In particular, as explained above, the example musical analysis engine 104 may determine, based on the analysing of the one or more spectrograms, and for all or part of the reference musical instrument performance: a performance structure; a rhythm map 212 of the reference musical instrument performance; a musical key; and/or a chord chart 218, 220. Determining of the rhythm map 212 may be based on dynamic variations and/or spectral-temporal variations.

### User Input Data 202

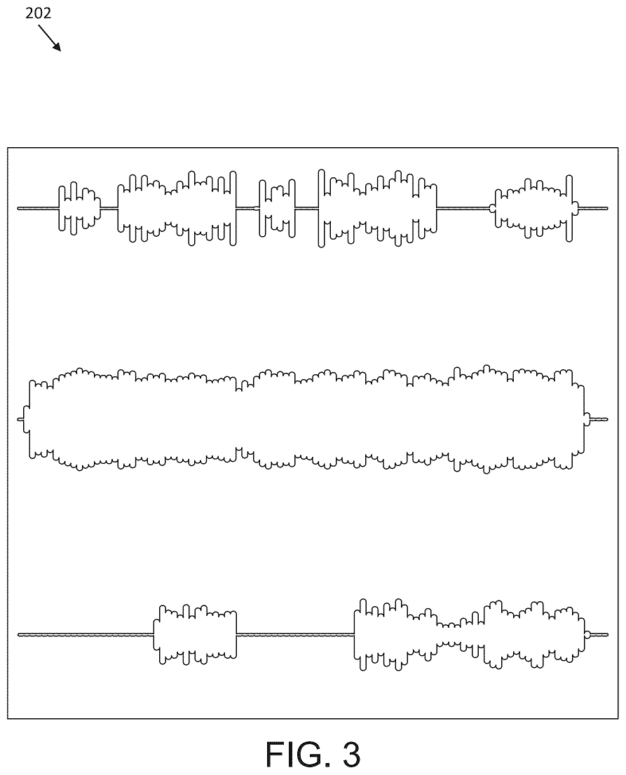

Referring to FIG. 3, there is shown an example of the user input data 202 described above with reference to FIG. 2. In this example, the user input data 202 comprises three audio waveforms.

In this example, the top waveform represents a reference guitar performance, the middle waveform represents a reference bass guitar performance, and the bottom waveform represents a reference piano performance. The waveforms all relate to each other as multi-track audio files. The reference performance that is used as the input to the musical analysis engine 104 may be one of the individual guitar, bass guitar or piano performances. Alternatively, the reference performance may be a mixed and/or summed version of two or more of the guitar, bass guitar and piano performances. For example, the reference performance may be a combination of guitar and bass guitar, or may be a combination of guitar, bass guitar and piano.

### Song Structure Chart 208

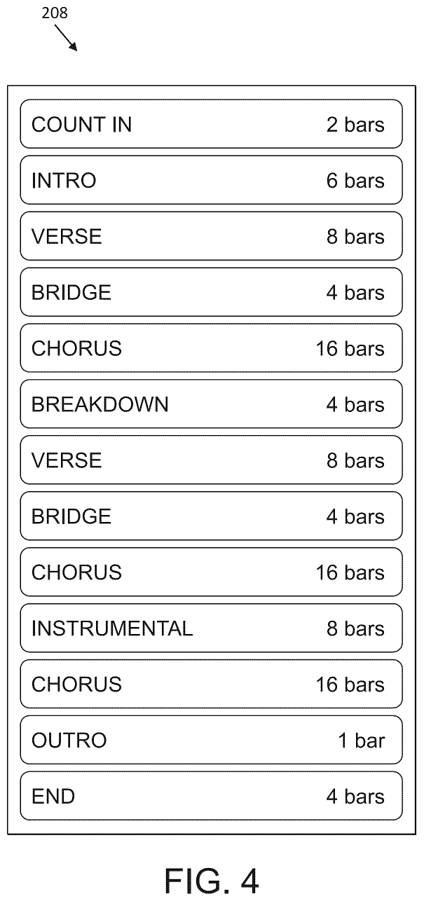

Referring to FIG. 4, there is shown an example of the song structure chart 208 described above with reference to FIG. 2. The example song structure chart 208 shows a set of automatically named sections of a song alongside a set of respective section lengths. In this example, the section lengths are indicated by a number of bars. In this example, the song structure chart 208 has been generated entirely by the musical analysis engine 104 based on analysing the recording of the reference musical instrument performance. In this example, the user has not provided any additional user input to define the song structure.

### Rhythm Map 212

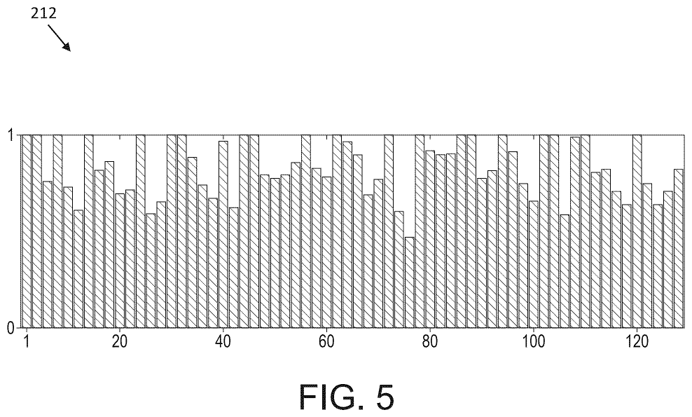

Referring to FIG. 5, there is shown an example of the rhythm map 212 described above with reference to FIG. 2. In this example, the rhythm map 212 shows dynamics over one-hundred-and-twenty-eight sub-divisions. The one-hundred-and-twenty-eight sub-divisions may correspond to eight bars of sixteenths. In this example, the x-axis of the chart represents sub-divisions, and the y-axis represents dynamic power, with the dynamic power being a value between 0 and 1. In other examples, the y-axis may represent signal power. In this specific example, the dynamic power is a rolling root mean square (RMS) measure, in which the RMS for a segment is compared to the RMS of the previous two segments to give a relative dynamic power.

### High-Resolution Chromagram 216

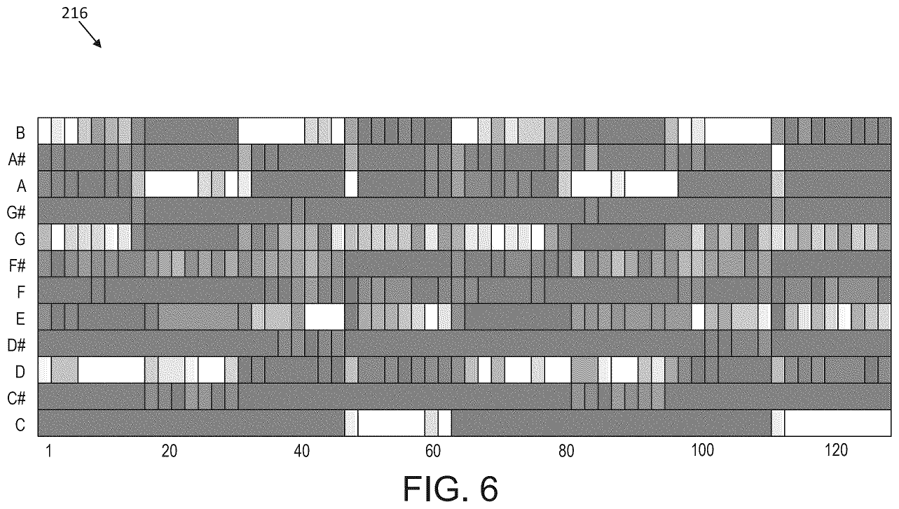

Referring to FIG. 6, there is shown an example of the high-resolution chromagram 216 described above with reference to FIG. 2. In this example, the high-resolution chromagram 216 is over a total of one-hundred-and-twenty-eight sub-divisions. In this example, the x-axis of the high-resolution chromagram 216 represents sub-divisions and the y-axis represents musical notes from C to B. The shading gradients in the chart represent intensity, with a dark shading gradient representing low intensity and a light shading gradient representing high intensity. For example, in sub-divisions 1 through 16, the notes D, G and B have light shading and, hence, high intensity.

### Cleaned Chromagram & Chart(s) 218

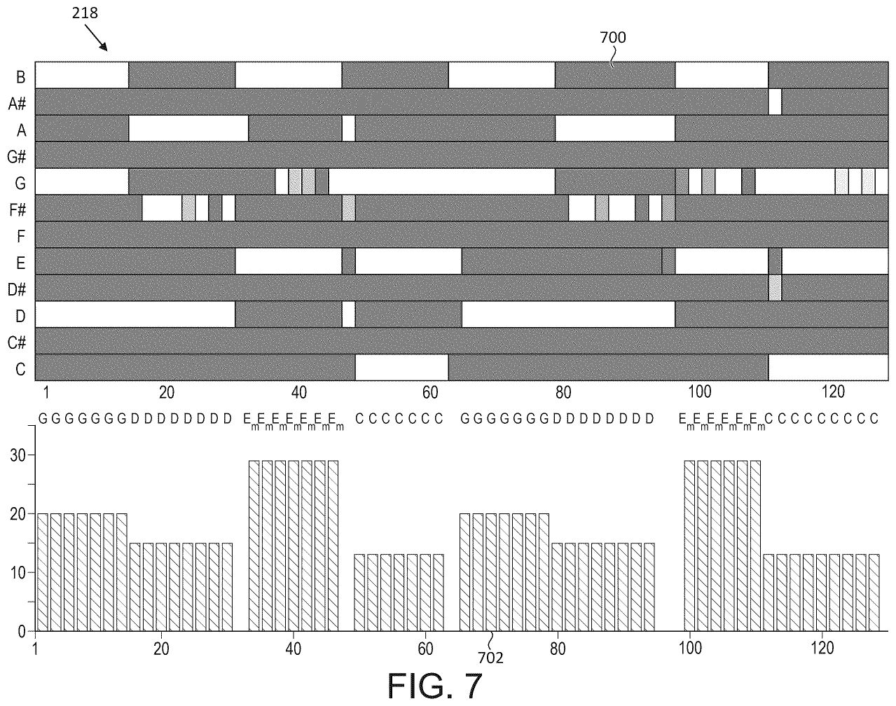

Referring to FIG. 7, there is shown an example of the cleaned chromagram and chart 218 (s) described above with reference to FIG. 2.

In this example, the cleaned chromagram and chart(s) 218 comprise a cleaned chromagram 700. In this example, the cleaned chromagram 700 corresponds to the high-resolution chromagram 216 after key detection has been performed. Such key detection may be algorithmic and/or may use a neural network.

Automatic key detection may be implemented by folding and averaging all columns of the segment chromagram 216 (shown in FIG. 6) into a single-column chromagram. The folded chromagram indicates which of the twelve musical notes have the highest intensity in the whole song segment. The seven most intense notes indicate the musical key of the segment. For example, if the most intense seven notes are C, D, E, F, G, A, B then the musical scale is C major or its relative minor scale of A minor. Equally if the most powerful seven notes are C#, D, E, F#, G#, A, B then the musical scale is A major or its relative minor scale of F# minor. The musical key can be identified from the folded chromagram by least error comparison with benchmark musical key profiles and/or by a trained neural network.

The cleaning process, for generating the cleaned chromagram 700, may use the identified segment key and a trained neural network to add confidence to the identification of chords. The neural network may be trained to intensify the correct notes in a chord and to attenuate incorrect notes in a chord. For example, the F# notes in sub-divisions 15 to 32 in the segment chromagram 216 shown in FIG. 6 have relatively low intensity. This may be as a result of a guitarist not holding the F# note sufficiently during the reference performance. Since the song key has been identified, the clean-up neural network can add focus to these notes and attenuate other notes that have a small amount of energy. Albeit imperfect, the clean-up process helps achieve improved results when converting a chromagram to a chord chart, as will be described in more detail below.

In this example, the cleaned chromagram and chart(s) 218 comprises a chord identification chart 702. In this example, the chord identification chart 702 identifies a chord for each sub-division, based on the cleaned chromagram 700. Such chord identification may be algorithmic and/or may use a neural network. In this example, the x-axis of the initial chord identification chart 702 represents sub-divisions and the y-axis represents a unique chord categorisation. The unique chord categorisation may correspond to a hash value or value map. For example, values of 1 to 12 may represent chords C5 to B5, values of 13 to 24 may represent C major to B major, values of 25 to 36 may represent C minor to B minor, and so on for other chord types such as sus2, sus4, etc. The value 0 may be used to indicate that no chord could be identified.

The chord identification chart 702 also shows, to facilitate understanding, the identified chord for each sub-division. For example, the chord G major is identified for sub-divisions 1 to 14, the chord D major is identified for sub-divisions 15 to 30, no chord is identified for sub-divisions 31 or 32, the chord E minor is identified for sub-divisions 33 to 46, and so on. Several gaps are present between steps, where the unique chord categorisation value is 0. This occurs when no chord could be detected. This is often the case when a guitarist or pianist changes chord shapes and positions.

### Chord Onset Chart 800

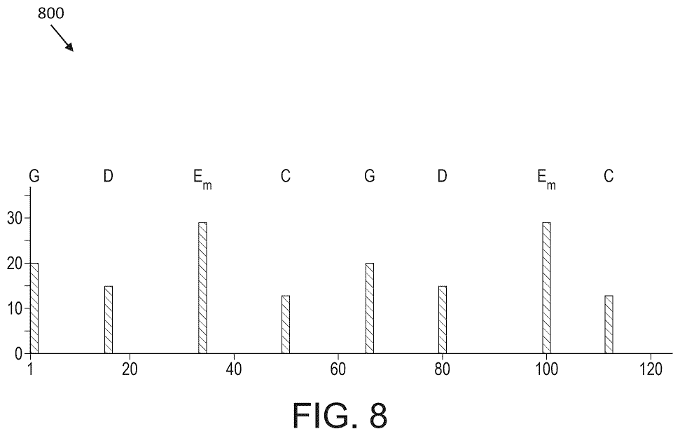

Referring to FIG. 8, there is shown an example of a chord onset chart 800. The chord onset chart 800 may be deduced from the chord identification chart 702. The chord onset chart 800 may be deduced algorithmically and/or using a neural network. The chord onset chart 800 is similar to the chord identification chart 702, but only represents chord changes.

### Chord Chart 220

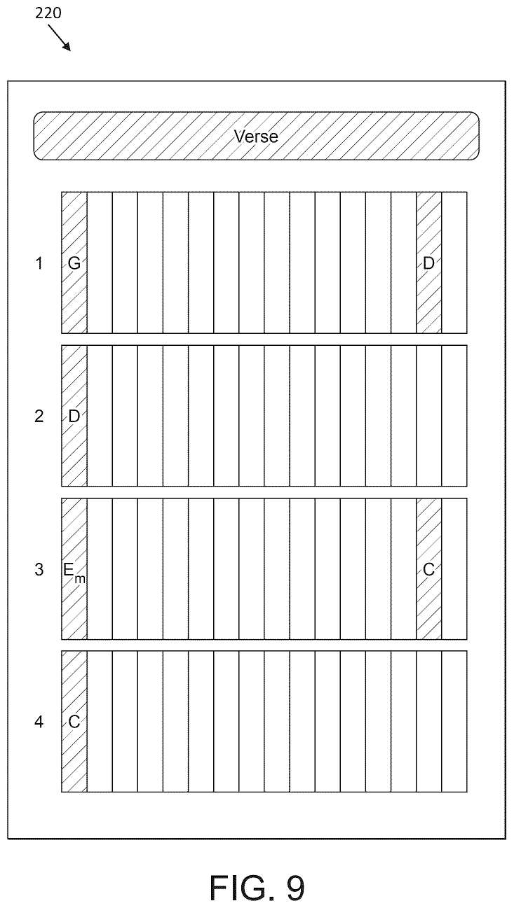

Referring to FIG. 9, there is shown an example of the chord chart 220 described above with reference to FIG. 2. The chord chart 220 may be output to the user.

This chord chart 220 is in a format that a session musician would be used to seeing.

The D, and also the C, is a pushed chord change and occurs slightly before the bar starts. The chord chart 220 shows not only when the chord changes, but also the active chord at the start of the bar. For example, the pushed D is shown on the fifteenth of the sixteen sub-divisions of the first bar and then again at the start of the second bar.

Although the verse is eight bars long, the verse uses a four-bar chord progression which repeats twice. The chord progression analysis component 214 identifies that the verse is a repeated four-bar pattern rather than a single eight-bar progression. In this way, the chord progression analysis component 214 can also average over minor timing discrepancies in the performance that is being analysed.

### Musical Analysis Implementation 1000

Referring to FIG. 10, there is shown an example musical analysis implementation 1000.

In this example, user input data, represented by item 202, is analysed.

In this example, the user input data 202 comprises four tracks. In this example, all four tracks are reference recordings that can be used individually or summed as a mixed reference recording.

The horizontal bar below the four tracks represents the identified song structure. The horizontal bar may be colour-coded. For example, different colours may be used for a verse, a chorus, a bridge etc. For convenience, the fader for the horizontal bar is a group fader that turns down all of the accompaniments. Accompaniments can have their volumes adjusted individually via a mixer screen.

Such analysis results in a song structure chart, represented by item 208.

The user input data 202 and the song structure chart 208 are used to generate a chord chart, represented by item 220.

FIG. 10 shows a chord chart editor function through which the user can edit the generated chord chart 220.

Each section of a song has, or at least could have, a different chord chart. The key is that detected algorithmically for that segment. The user can change the detected key. The key enables a playback algorithm to determine the notes that can or cannot be played by the accompaniment. For example, in the key of G, a bassline may play an A note. However, the bassline should not play an F note, which is out-of-key for the section.

### Algorithmic Orchestration Engine 106

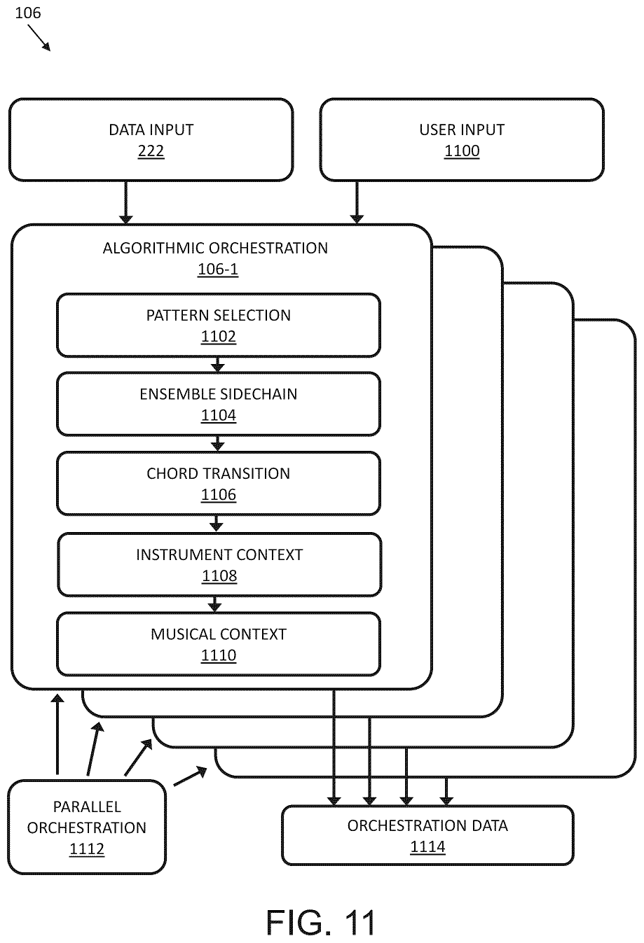

Referring to FIG. 11, there is shown an example of the algorithmic orchestration engine 106 described above with reference to FIG. 1.

The example algorithmic orchestration engine 106 obtains a data input 222. In this example, the data input 222 comprises the musical analysis data 222 output by the musical analysis engine 104.

The musical analysis data 222 may represent the deduced song structure 208, such as segments of the song. The musical analysis data 222 may represent the deduced rhythm map 212 for each segment and/or all of the song. The musical analysis data 222 may represent the deduced chord chart for each segment and/or all of the song. The musical analysis data 222 may represent the deduced musical key for each segment and/or all of the song.

In this example, the algorithmic orchestration engine 106 obtains a user input 1100.

In some examples, the user input 1100 indicates an orchestration role. Examples of orchestration role include, but are not limited to, beat, bass, pad and rhythm.

In some examples, the user input 1100 indicates a musical instrument. Examples of musical instrument include, but are not limited to, drums, synthesiser, piano and cello.

In some examples, the user input 1100 indicates that the user wishes to listen to, review, and/or modify one or more generated accompaniments.

In this example, the algorithmic orchestration engine 106 comprises the first through fourth algorithmic orchestration components 106-1, 106-2, 106-3, 106-4 described above with reference to FIG. 1.

In this example, each of the first through fourth algorithmic orchestration components 106-1, 106-2, 106-3, 106-4 comprises a pattern selection component 1102.

In this example, the pattern selection component 1102 deduces a set of viable patterns. Such patterns may also be referred to as “viable compositions”. Such patterns may be deduced from musical knowledge and/or ML. For example, thousands of viable patterns may be deduced. In this example, the viable patterns are transposed for all chords in the chord chart. Different patterns may be viable for different genres.

The algorithmic orchestration engine 106 may therefore use intelligently developed musical patterns. In more detail, within a single octave of twelve notes across a bar of sixteen sixteenths, over 1.85×10¹⁷ different musical phrases can be played. Some of these sound musically good and others do not. Some sound musically good in a certain context but do not sound musically good in other contexts. In some examples, the algorithmic orchestration engine 106 uses intelligent filtering to give potential musical patterns to the user. In some examples, such filtering involves a combination of implementing musical ‘rules’ of harmony and/or structure, and also machine-learnt knowledge that relates to different genres and/or performance styles. In a given scenario, a user can, therefore, be provided with a prioritised selection of patterns to review and choose from. Intelligent-filtered performance patterns therefore give the user a range of options to select from. Genre-mapping may allow a user to generate genre-specific patterns quickly through a second layer of pattern-filtering. Such genre-mapping may use machine-learnt data.

Thus, by using the pattern selection component 1102, generating a first and/or second musical instrument accompaniment may comprise selecting a subset of candidate musical patterns from a set of plausible musical patterns for the first and/or second musical instrument accompaniment. The selecting may be based on the reference musical instrument performance.

Each of the first through fourth example algorithmic orchestration components 106-1, 106-2, 106-3, 106-4 comprises an ensemble sidechain component 1104. The example ensemble sidechain component 1104 has, as input, an output of the pattern selection component 1102.

The ensemble sidechain component 1104 may link a bass musical instrument to a drum beat. The ensemble sidechain component 1104 may avoid rhythm piano from encroaching on notes played by a bass guitar.

The ensemble sidechain component 1104 may complement in harmony, register and/or rhythm.

The ensemble sidechain component 1104 may have a plurality of sidechains.

The algorithmic orchestration engine 106 may therefore use a feature that allows computer-generated basslines to be synchronised with a predefined or measured drum pattern. For example, a bassline may be locked to a kick drum pattern and/or a hi-hat swing.

More generally, a first musical instrument accompaniment may be rhythmically correlated with a second musical instrument accompaniment and/or with a reference musical instrument performance. Similarly, a second musical instrument accompaniment may be rhythmically correlated with a first musical instrument accompaniment and/or with a reference musical instrument performance.

Automated compositions as described herein therefore work across musical instruments rather than in isolation. For example, the bass may be allowed to respond to the drums and may also be contextual to other musical instruments. This generates a much more synchronised and musical output than in the case of isolated automated composition. Such synchronisation may, for example, be between drums and bass, between rhythm piano and violin, and/or between any number of musical instruments. Thus, performances may be synchronised between musical instruments.

In particular, a first musical instrument accompaniment can be generated to accompany a reference musical instrument performance. The first musical instrument accompaniment can be based on the reference musical instrument performance.

Similarly, a second musical instrument accompaniment can be generated to accompany the reference musical instrument performance. The second musical instrument accompaniment can be based on the first musical instrument accompaniment. The second musical instrument accompaniment may also be based on the reference musical instrument performance.

The first musical instrument accompaniment may be generated based on the data input 222, and the second musical instrument accompaniment may be generated using the ensemble sidechain component 1104.

The first and/or second musical instrument accompaniment may be based on one or more musical properties of the reference musical instrument performance. The first musical instrument accompaniment may be based on one or more musical properties of the second musical instrument performance. The second musical instrument accompaniment may be based on one or more musical properties of the first musical instrument performance. The one or more musical properties may comprise harmony, melody and/or rhythm.

The ensemble sidechain component 1104 may be used to regenerate the first musical instrument accompaniment based on the second musical instrument accompaniment and/or vice versa. Such regenerating may be based on one or more modifications made to the applicable musical instrument accompaniment. The one or more modifications may comprise a user-triggered modification.

The sharing of data between the accompaniment engines may be considered to be a multiplexed arrangement of data. With multiplex or signal busses, any component can evaluate and respond to data that is on the bus, and any component can update the data for which it is responsible. This can provide a degree of crosstalk between components.

Each of the first through fourth example algorithmic orchestration components 106-1, 106-2, 106-3, 106-4 comprises a chord transition component 1106. The example chord transition component 1106 has, as input, an output of the ensemble sidechain component 1104.

The chord transition component 1106 may create intelligent transitions between chords. This can humanise a computer-generated accompaniment. The chord transition component 1106 may create a passing note, drum fill and/or flourish for drumming accompaniments. For a bass musical instrument, a bass note transition may involve a number of approaches; triadic, pentatonic, chromatic, fifth or other scalar approach. Additionally, the number of notes in the transition might be a single passing note, a complex pattern of notes, or one which takes the least number of tonal steps during the transition.

The algorithmic orchestration engine 106 may therefore use intelligent transitions. When moving from one chord to another, a human musician will often assess the journey from their current chord to the next, and play a transition that suits the performance style and/or musical key. By using intelligent transitions, the algorithmic orchestration engine 106 can use a number of different strategies that are, for example, triadic, pentatonic or chromatic. In some examples, given one or more user parameters, the algorithmic orchestration engine 106 chooses transition notes to play and chooses a suitable transition rhythm when changing chords. Intelligent transitions therefore provide a closer representation to a human performance by algorithm.

Thus, by using the chord transition component 1106, generating the first and/or second musical instrument accompaniment may comprise incorporating one or more humanizing transitions into first and/or second musical instrument accompaniments.

Each of the first through fourth example algorithmic orchestration components 106-1, 106-2, 106-3, 106-4 comprises a musical instrument context component 1108. The example musical instrument context component 1108 has, as input, an output of the chord transition component 1106.

The musical instrument context component 1108 may, for example, limit to certain frets on an acoustic guitar, restrict chord inversions to a single octave on a keyboard, and/or apply a root-above, root-below or root-between-the-third-and-fifth pattern on a bass guitar.

The algorithmic orchestration engine 106 may therefore use musical instrument context. Different musical instruments have different rules and methods of playing. For example, in some styles of music, a bass guitar may be played on two strings and within a single octave range. A left hand on piano, however, may play a bassline covering over three octaves. Equally, a bass pattern may play a chord root as the lowest note of a phrase and move up to the third and fifth of the chord. However, it is sometimes more suitable for a bass pattern to play down from the root, to the fifth, and then to the third, in a pattern. Additionally, an accompanying keyboard player may play chord inversions within a ‘boxed’ (in other words, limited or restricted) tonal register. This is because other musical instruments occupy other musical registers. When playing in a box, the keyboard player may change the inversion of a chord to fit within the box, rather than moving up and down in range with a single inversion shape (which may be referred to as “parallel movement”). These decisions are made by musicians based on what patterns are played by other musical instruments at the time. In some examples, the algorithmic orchestration engine 106 evaluates these contexts and makes intelligent decisions. Musical instrument context therefore allows compositions to be intelligently arranged for specific musical instruments.

Thus, by using the instrument context component 1108, generating the first and/or second musical instrument accompaniment may comprise incorporating musical instrument context into first and/or second musical instrument accompaniments.

Each of the first through fourth example algorithmic orchestration components 106-1, 106-2, 106-3, 106-4 comprises a musical context component 1110. The example musical context component 1110 has, as input, an output of the musical instrument context component 1108.

The musical context component 1110 may manage ‘out-of-key’ chords, for example playing notes within a specific chord triad to avoid performing any dissonant notes that are out-of-key with the segment as a whole. The musical context component 1110 may manage ‘accidental’ and/or non-diatonic notes. The musical context component 1110 may apply an arrangement context. For example, the musical context component 1110 may scale up into a chorus, scale down when moving to a verse, etc. The musical context component 1110 may use triplets and/or may actively break time signature rules to deliver a more advanced or human-like accompaniment.

Thus, by using the musical context component 1110, generating the first and/or second musical instrument accompaniment may comprise incorporating musical context into first and/or second musical instrument accompaniments.

As indicated by item 1112, multiple algorithmic orchestration layers, musical instruments, and/or functions combine and interact to provide parallel orchestration.

Each of the first through fourth example algorithmic orchestration components 106-1, 106-2, 106-3, 106-4 outputs data which, collectively, provides orchestration data 1114. In this example, the orchestration data 1114 is provided to the performance engine system 108 described above with reference to FIG. 1. The orchestration data 1114 is an example of musical instrument accompaniment data that may be generated in accordance with techniques described herein.

### Performance Engine & Music Production Subsystem 1200

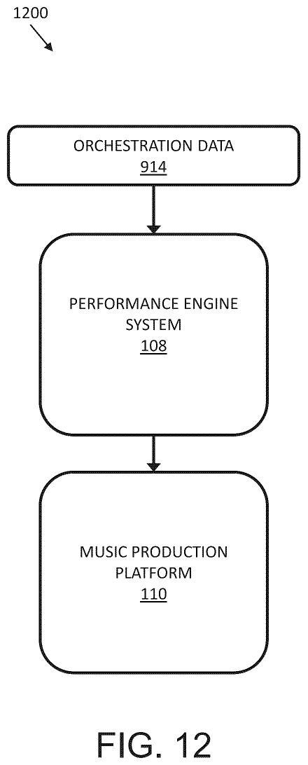

Referring to FIG. 12, there is shown an example of a performance engine and music production subsystem 1200 of the example system 100 described above with reference to FIG. 1.

In this example, the performance engine and music production subsystem 1200 comprises the performance engine system 108 and music production platform 110 described above with reference to FIG. 1.

The example performance engine system 108 obtains the orchestration data 914 output by the algorithmic orchestration engine 106.

The performance engine system 108 uses one or more types of data and/or technique. For example, the performance engine system 108 may use and/or control: one or more sample packs, performance velocity, sustain, legato, attack, decay, release, swing, dynamics, variance, one or more effects, expression, timbre, muting, slides, glissando, vibrato, pitch-bend, dissonance, and/or harmonics.

Thus, the musical instrument accompaniment data described herein may comprise dynamic expression information, temporal information, timbral information, and/or spectral expression information.

In some examples, generating the musical instrument accompaniment data comprises: synthesising first and second musical instrument accompaniments and the musical instrument accompaniment data comprises audio data representing the synthesised first and second musical instrument accompaniments.

The example music production platform 110 has, as input, an output of the performance engine system 108.

The music production platform 110 may provide multi-track recording, editing, mixing, effects processing, summation and playback, export and/or rendering.

An output of the music production platform 110 is an example of musical instrument accompaniment data as described herein.

### Algorithmic Orchestration and Performance Engine Implementation and User Interaction

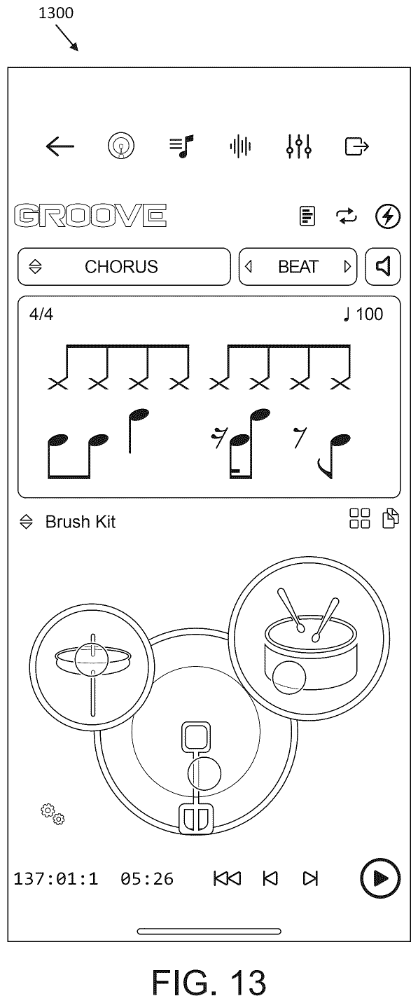

Referring to FIG. 13, an example graphical user interface (GUI) 1300 is shown. Using the example GUI 1300, the user can change an accompanying drum pattern and/or the particular virtual drum kit used.

The user can move the control dots around the drum kit and generate new drum accompaniment patterns quickly. The auto-accompaniment of other instruments then responds to such modification. Equally, the user can tap on the drum notation to add and/or remove notes quickly and, hence, override suggested drum accompaniment data. Other instruments may then follow the new pattern(s) that the user has chosen.

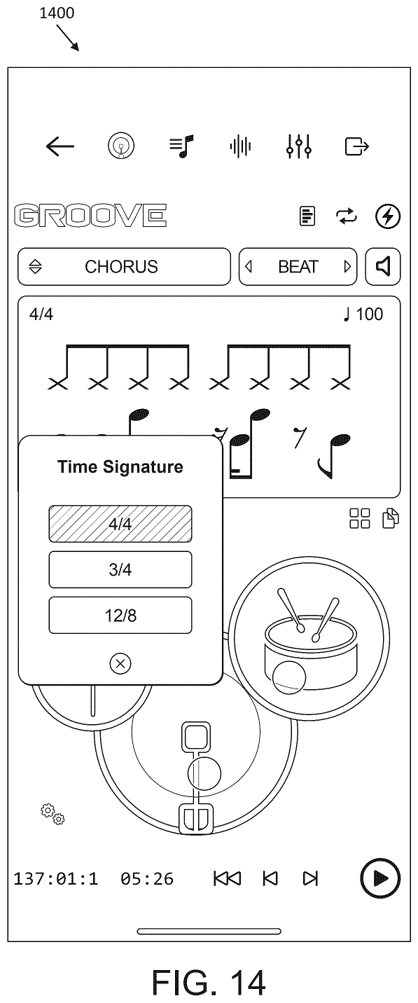

Referring to FIG. 14, another example GUI 1400 is shown. Using the example GUI 1400, the user can change an accompanying time signature used.

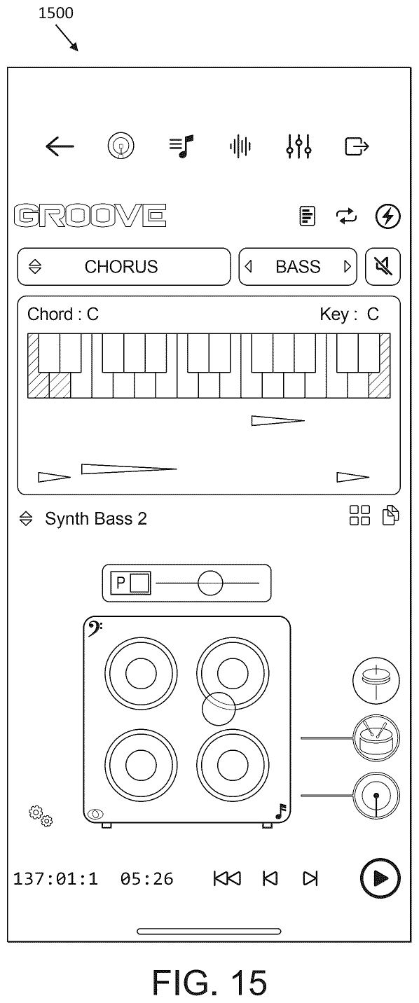

Referring to FIG. 15, another example GUI 1500 is shown. Using the example GUI 1500, the user can change an accompanying bass pattern and/or the particular virtual bass musical instrument used.

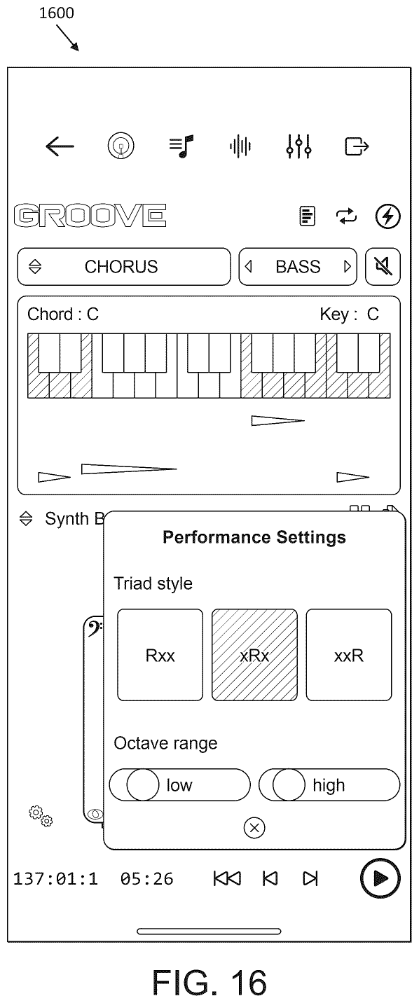

Referring to FIG. 16, another example GUI 1600 is shown. Using the example GUI 1600, the user can change performance settings used for an accompanying bass musical instrument. In this specific example, the user can change triad style and octave range.

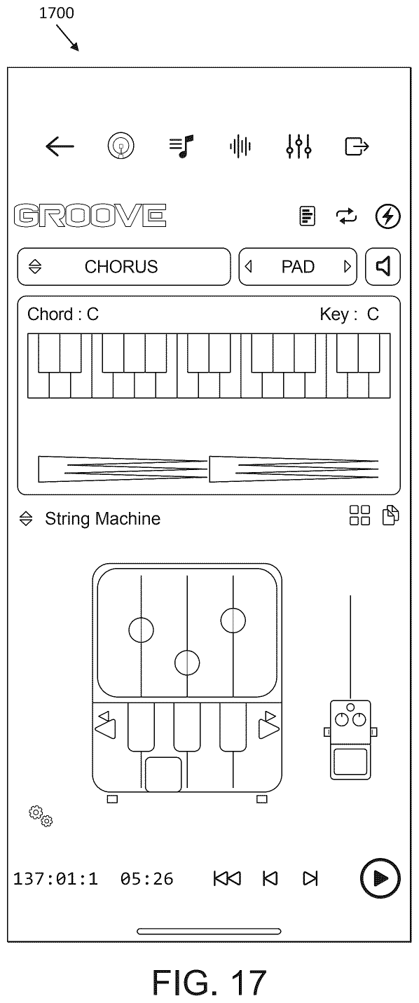

Referring to FIG. 17, another example GUI 1700 is shown. Using the example GUI 1700, the user can change an accompanying pad pattern and/or the particular virtual string musical instrument(s) used.

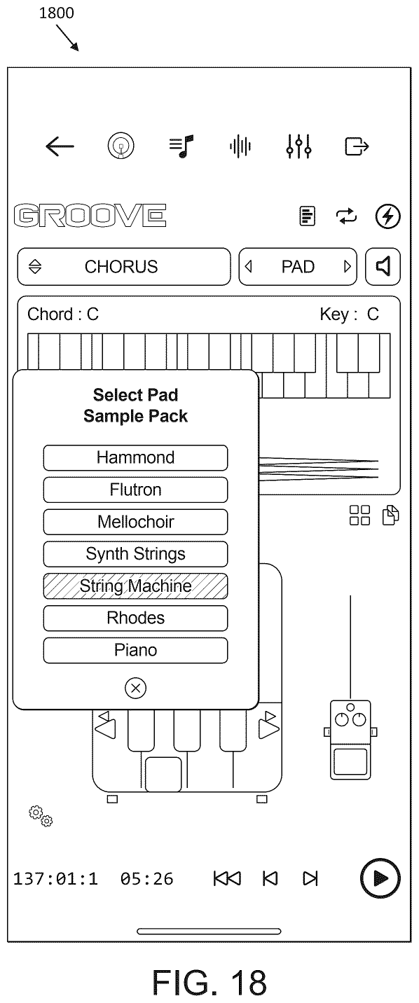

Referring to FIG. 18, another example GUI 1800 is shown. Using the example GUI 1800, the user can change a sample pack used for an accompanying pad musical instrument.

### Computing Device 1900

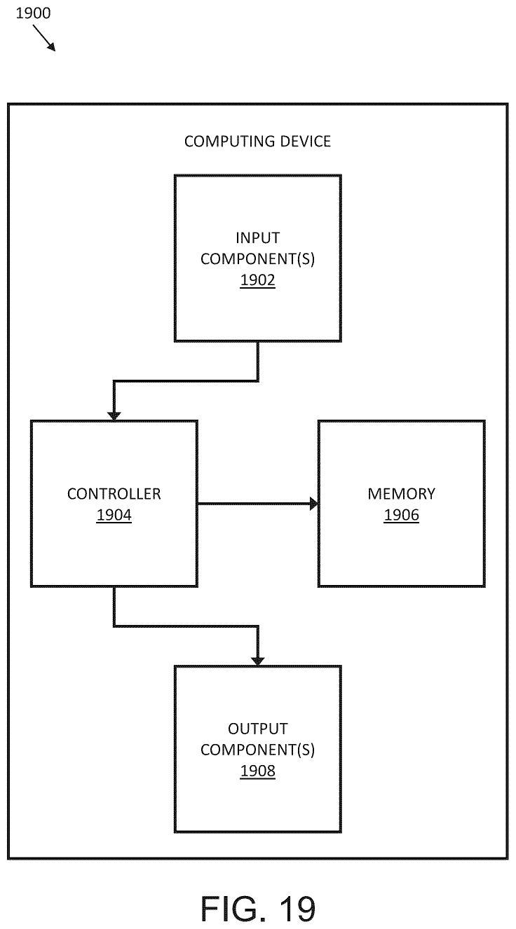

Referring to FIG. 19, there is shown an example computing device 1900. The computing device 1900 may be configured to perform at least some of the techniques described herein.

The computing device 1900 may take various different forms. In some examples, the computing device 1900 is a user device. The term “user device” is used herein to mean a device that is used directly by a user. In contrast, a server device that the user cannot directly control or access is not a user device. In some examples, the computing device 1900 is a mobile computing device. Examples of mobile computing devices include, but are not limited to smartphones, tablet computers and laptop computers.

In this example, the computing device 1900 comprises one or more input components 1902. An example of an input component is a sensor. Examples of input components 1902 include, but are not limited to, microphones, preamplifiers, analog-to-digital converters (ADCs). The input component(s) 1902 may be used to record music into the computing device 1900.

In this example, the computing device 1900 comprises a controller 1904. The controller 1904 is configured to control the computing device 1900 such that the computing device 1900 performs at least some of the techniques described herein. The controller may comprise a central processing unit (CPU) or any other type of processor.

In this example, the computing device 1900 comprises a memory 1906. The memory 1906 may store computer-readable instructions which, when executed by the controller 1904, cause the controller to control the computing device 1900.

In this example, the computing device 1900 comprises one or more output components 1908. Examples of output components 1908 include, but are not limited to, radio frequency (RF) transmitters, headphone sockets, headphones, built-in loudspeakers etc. The RF transmitter may comprise a Bluetooth transmitter, a Wi-Fi transmitter, a wireless mobile telecommunications technology transmitter. Examples of wireless mobile telecommunications technology transmitters include, but are not limited to, 3G, 4G and 5G transmitters.

### Example Implementation

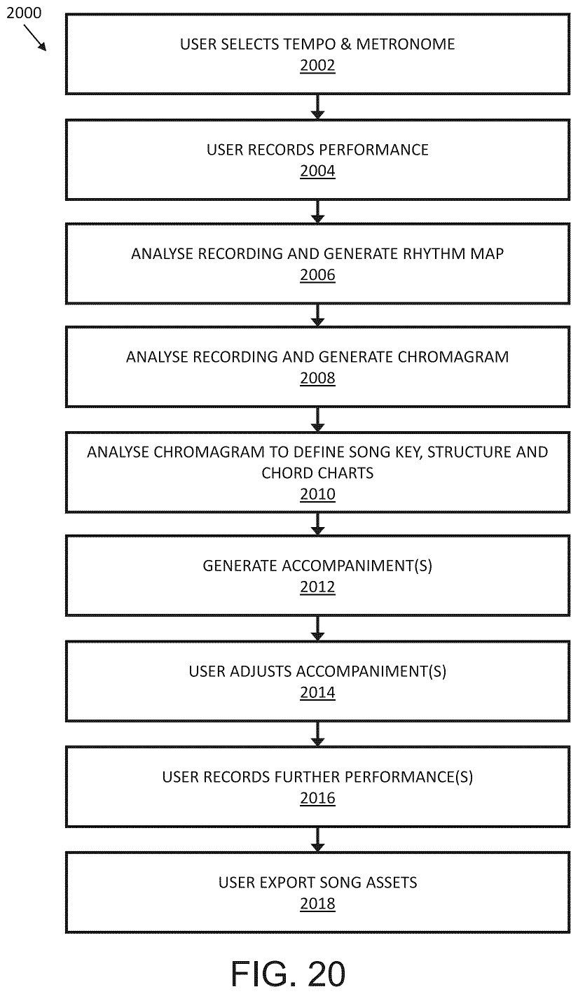

Referring to FIG. 20, there is shown an example of a method 2000.

In this specific example, the method 2000 is performed on a mobile device that has an enhanced version of the Songzap application from RT Sixty Ltd. The application is enhanced in that it performs at least some of the automated accompaniment techniques described herein.

By way of a summary, after a user records a performance, for example a guitar recording, the application quickly embellishes the recorded audio to have accompanying drums, bass, piano and strings. This turns a single-track recording into a multi-layered song in a matter of seconds. For example, it may take around one second to generate a simple loop-based song, and it might take around thirty seconds for a full song with a large number of recordings to analyse.

In terms of an example user journey, at item 2002, the user selects a metronome tempo and a time signature. However, as explained above, tempo and/or time signature may be detected automatically in other examples.

At item 2004, the user records an acoustic guitar performance using a built-in microphone of their user device. The performance could use a different musical instrument in other examples.

At item 2006, the recording is analysed, and a rhythm map is generated. A drumbeat may be generated from the rhythm map.

At item 2008, a spectrogram for the recording is created. This is converted to a chromagram for the recording.

A song structure may be identified for the recording (verse, chorus, etc.) by identifying patterns in the chromagram. Alternatively, the recording may be considered to be a single structure, namely one segment encompassing everything recorded.

At item 2010, the one or more segments are analysed for musical key and then to deduce a chord chart for the segment(s).

At item 2012, each section of the song is layered with drums, bass, piano and strings that accompany the original guitar performance and recording. As explained above, the accompanying musical instrument type(s) may be different in other examples.

At item 2014, the user can adjust the automated accompaniments. For example, the user may select different control parameters for each musical instrument. The user may also manually choose and/or adapt the composed patterns.

At item 2016, the user continues recording and finishes a demonstration song. The demonstration song can be mixed, and bounced and/or exported.

At item 2018, all song assets may be exported for further manipulation in a DAW software package. For example, the song assets may be exported as MIDI and/or WAV files.

The user journey may be non-linear. For example, guitar recording could be accompanied by only drums, then a piano recording captured, and then a string composition may be automatically generated to accompany the guitar and piano recordings and the generated drums.

In some examples, a user can enter the chord chart and/or song structure data manually and compose a musical instrument performance which has no recorded elements. The chord chart represents the type of information given to a session musician at a live performance or studio session. The communication methods of musicians in a creative process may therefore be closely replicated.

### Example Flowcharts

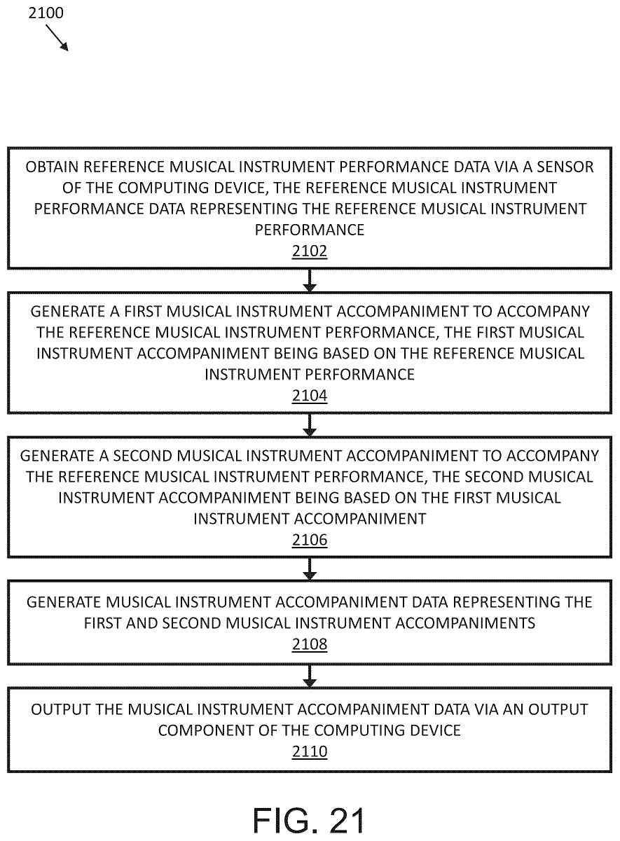

Referring to FIG. 21, there is shown an example of a computer-implemented method 2100 of controlling a computing device to generate musical instrument accompaniments to accompany a reference musical instrument performance.

At item 2102, reference musical instrument performance data is obtained via a sensor of the computing device. The reference musical instrument performance data represents the reference musical instrument performance.

At item 2104, a first musical instrument accompaniment to accompany the reference musical instrument performance is generated. The first musical instrument accompaniment is based on the reference musical instrument performance.

At item 2106, a second musical instrument accompaniment to accompany the reference musical instrument performance is generated. The second musical instrument accompaniment is based on the first musical instrument accompaniment.

At item 2108, musical instrument accompaniment data representing the first and second musical instrument accompaniments is generated.

At item 2110, the musical instrument accompaniment data is output via an output component of the computing device.

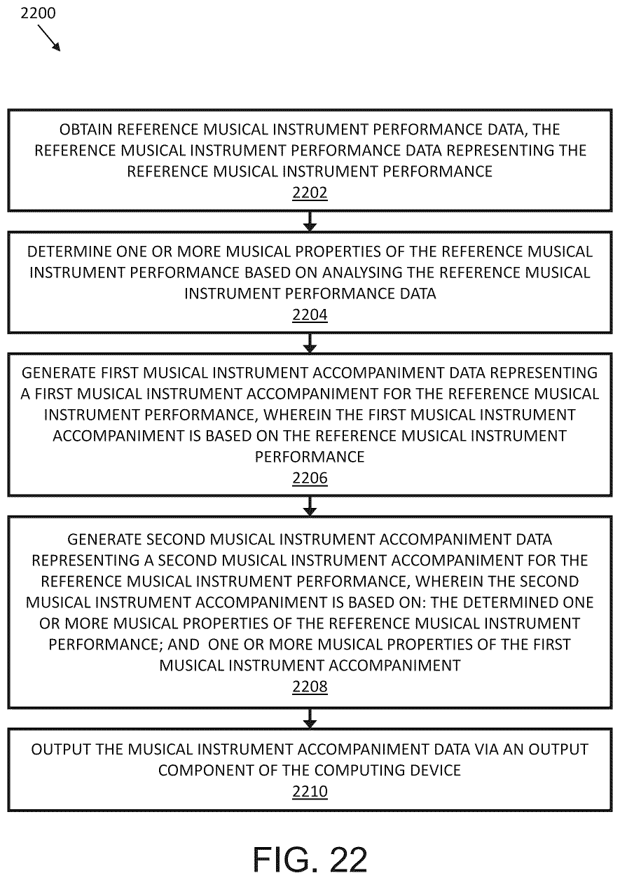

Referring to FIG. 22, there is shown an example of a computer-implemented method 2200.

At item 2202, reference musical instrument performance data is obtained. The reference musical instrument performance data represents the reference musical instrument performance.

At item 2204, one or more musical properties of the reference musical instrument performance are determined based on analysing the reference musical instrument performance data.

At item 2206, first musical instrument accompaniment data representing a first musical instrument accompaniment for the reference musical instrument performance is generated. The first musical instrument accompaniment is based on the reference musical instrument performance.

At item 2208, second musical instrument accompaniment data representing a second musical instrument accompaniment for the reference musical instrument performance is generated. The second musical instrument accompaniment is based on: the determined one or more musical properties of the reference musical instrument performance; and one or more musical properties of the first musical instrument accompaniment.

At item 2210, the first and second musical instrument accompaniment data are output.

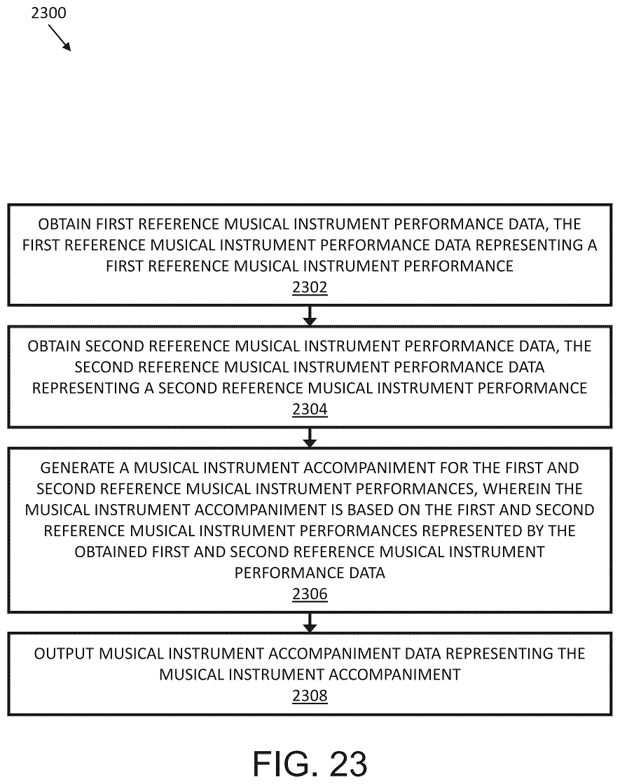

Referring to FIG. 23, there is shown an example of a computer-implemented method 2300 of controlling a computing device to generate a musical instrument accompaniment for reference musical instrument performances.

At item 2302, first reference musical instrument performance data is obtained. The first reference musical instrument performance data represents a first reference musical instrument performance.

At item 2304, second reference musical instrument performance data is obtained. The second reference musical instrument performance data represents a second reference musical instrument performance.

At item 2306, a musical instrument accompaniment for the first and second reference musical instrument performances is generated. The musical instrument accompaniment is based on the first and second reference musical instrument performances represented by the obtained first and second reference musical instrument performance data.

At item 2308, musical instrument accompaniment data representing the musical instrument accompaniment is output.

### Conclusion

Examples described herein provide automated methods for generating musical instrument accompaniments.

A music performance may be captured. The performance may be analysed to deduce harmony, melody and/or rhythm data. A musical composition that accompanies the analysed performance may be generated. Musical performance data for articulating the composition may be generated. The generated accompaniment may be output to the user in one or multiple forms, such as written, sound and/or MIDI.

The generated composition may comprise multiple compositions for different musical instruments. In other words, the generated composition may be an ensemble score.

The generated multiple compositions may utilise shared harmony, melody and/or rhythm data between the musical instruments to generate complementary musical parts (which may also be referred to as “individual musical instrument scores”). For example, in terms of shared harmony data, if the bass plays the root of the chord, the piano can play extended chord voicings that do not include the root. In terms of shared melody data, piano inversions (voice-leading) may be chosen to match a violin melody. In terms of shared rhythm data, a bass guitar may follow a kick drum pattern.

The generated compositions(s) may incorporate intelligent transitions based on performance analysis data. For example, harmony and/or compositional structure may change, for example as a result of a chord change, harmonic movement or progression etc. A generated melody (including, for example, a bassline) can variate with knowledge of the upcoming chord (in other words, lookahead) and by making an intelligent melodic movement or motif proceeding and leading into the chord change.

Musical instrument context may be incorporated. For example, ‘boxing’ (selecting a fixed range) may be used on a keyboard to create chord inversions that complement the other musical instrument ranges. In another example, register limitation may be used for a bass guitar, to avoid clashing with a keyboard and/or piano range.

Musical context may be incorporated. For example, a track may be in a 4/4 time signature. However, a short triplet (12/8) motif on the drums may be identified as viable in a certain moment. In another example, an out-of-key chromatic passing note may be played on the bass guitar when changing chords.

A user may be able to influence the generation of the composition(s) by setting rules, conditions or preferences and/or by responding to the output forms. For example, ten potential drum parts may be provided, and the user may choose their favourite. In another example, a user may indicate that a bassline should align with a hi-hat pattern. In another example, a user may choose from a pool of transition algorithms, for example three transition algorithms. The user may be able to choose articulation variables (for example, time, amount, type, and speed) when engaging a tremolo effect over a Hammond organ composition.

Thus, generating first and/or second musical instrument accompaniments may comprise following one or more user-defined rules.

The generated performance data may comprise performance data for multiple different musical instruments. For example, performance data may comprise performance data for musical instrument in an ensemble.

The performance data may be in the form of dynamic expression information. For example, this may represent accents, tremolo effect, pianissimo, fortissimo, velocity, crescendo, etc.

The performance data may be in the form of temporal information. For example, this may define if the performance should be swung, behind-the-beat, staccato, legato, etc.

The performance data may be in the form of timbral information. For example, this may represent effects such as chorus, doubler, distortion, sample pack choice, etc.

The performance data may be in the form of spectral expression information. This represents pitch or frequency. This may represent, vibrato, glissando, filter sweep, wah-wah control, etc.

Analysing may include generating a score structure of compositional sections, for example verse, chorus, musical instrument etc.

Analysing may include generating one or more chord charts (for example, representing chord changes at designated positions) for the whole performance or for each compositional section.

Analysing may include generating one or more rhythm charts based on dynamic and/or spectral-temporal variations for the whole performance or for each compositional section.

The musical key may be identified for the whole performance and/or for different compositional sections.

Tempo and/or tempo changes may be identified.

Time signature(s) and/or time signature changes may be identified.

### Alternatives

At least some processing may be performed on a remote server. This may allow greater algorithmic possibilities. However, this may be at the expense of speed and offline capability.

An accompaniment may be for the same instrument as the instrument that is used for the reference performance. For example, a piano melody played with a right hand may serve as a reference performance, and piano chords that would be played with a left hand may be generated as an accompaniment. For a rhythm guitar reference performance, a lead guitar accompaniment may be generated.

In some examples, accompaniment data may be output as MIDI. However, such MIDI might not be synthesised to generate corresponding audio data. For example, such MIDI may be converted into tablature or another form of notation, and an accompaniment could be performed by a musician and recorded accordingly.

The user may be able to indicate a reference performance without playing the reference performance on a musical instrument. For example, the user may write out notation representing the reference performance by hand. A photograph of the handwritten notation may be captured. The photograph may be analysed to determine the intended reference performance. In another example, the user may create a MIDI file representing the reference performance without actually playing the reference performance on a musical instrument. In general, the reference performance may be represented by non-audio data in some examples. Such non-audio data may be analysed and responded to in order to generate one or more accompaniments.

In some examples, two inputs are analysed, and one output is generated. The two inputs may, for example, be audio and audio, audio and MIDI, or MIDI and MIDI. Other types of non-audio input may also be used, such as an image or notation. Therefore, two reference performances may be analysed and one accompaniment may be generated to compliment both of the reference tracks.

Separate Virtual Studio Technology (VST) implementations may be developed for each musical instrument type. However, this may limit the amount of sidechain and symbiosis that can be automatically achieved between musical instruments. This is because separate VST plugins may not be able to communicate with each other readily in the manner described above.

The performance engine system 108 may be implemented within a sample pack or VST musical instrument. For example, a VST orchestra musical instrument could also include AI performer and/or composer features.

A real-time version may respond and compose as it listens to a real-time performance. The real-time version could, therefore, act as one or more real-time band members. Latency between listening and performing becomes more relevant. However, acceptable latency may nevertheless be attained based on techniques described herein.

Headings are used herein for readability purposes and not by way of limitation.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims. CLAIMS

1. A computer-implemented method of controlling a computing device to generate musical instrument accompaniments to accompany a reference musical instrument performance, the method comprising:
obtaining reference musical instrument performance data via a sensor of the computing device, the reference musical instrument performance data representing the reference musical instrument performance;
generating a first musical instrument accompaniment to accompany the reference musical instrument performance, the first musical instrument accompaniment being based on the reference musical instrument performance;
generating a second musical instrument accompaniment to accompany the reference musical instrument performance, the second musical instrument accompaniment being based on the first musical instrument accompaniment;
generating musical instrument accompaniment data representing the first and second musical instrument accompaniments; and
outputting the musical instrument accompaniment data via an output component of the computing device.

2. The method of claim 1, comprising:
regenerating the first musical instrument accompaniment based on the second musical instrument accompaniment.

3. The method of claim 1, comprising:
regenerating the first musical instrument accompaniment based on one or more modifications made to the second musical instrument accompaniment; and/or
regenerating the second musical instrument accompaniment based on one or more modifications made to the first musical instrument accompaniment.

4. The method of claim 3, wherein the one or more modifications comprise a user-triggered modification.

5. The method of claim 1, wherein the second musical instrument accompaniment:
is based on the reference musical instrument performance; and/or
is rhythmically correlated with the first musical instrument accompaniment.

6. The method of claim 1, wherein:
the first and/or second musical instrument accompaniment is based on one or more musical properties of the reference musical instrument performance;
the first musical instrument accompaniment is based on one or more musical properties of the second musical instrument performance; and/or
the second musical instrument accompaniment is based on one or more musical properties of the first musical instrument performance,
wherein the one or more musical properties comprise harmony, melody and/or rhythm.

7. The method of claim 1, comprising:
analysing the reference musical instrument performance data;
determining, based on the analysing, and for all or part of the reference musical instrument performance:
one or more tempos;
one or more tempo changes;
one or more time signatures;
one or more time signature changes; and/or
one or more other temporal characteristics.

8. The method of claim 1, comprising:
generating one or more spectrograms representing the reference musical instrument performance; and
analysing the one or more spectrograms,
wherein the first and/or second musical instrument accompaniment is based on the analysing of the one or more spectrograms.

9. The method of claim 8, comprising:
determining, based on the analysing of the one or more spectrograms, and for all or part of the reference musical instrument performance:
a performance structure;
a rhythm map of the reference musical instrument performance;
a musical key; and/or
a chord chart.

10. The method of claim 9, wherein the determining of the rhythm map is based on dynamic variations and/or spectral-temporal variations.

11. The method of claim 1, wherein generating the first and/or second musical instrument accompaniment comprises:
selecting a subset of candidate musical patterns from a set of plausible musical patterns for the first and/or second musical instrument accompaniment, wherein the selecting is based on the reference musical instrument performance.

12. The method of claim 1, wherein generating the first and/or second musical instrument accompaniment comprises:
incorporating one or more humanizing transitions into the first and/or second musical instrument accompaniment;
incorporating musical instrument context into the generating;
incorporating musical context into the generating; and/or
following one or more user-defined rules.

13. The method of claim 1, wherein the first musical instrument accompaniment is for a first musical instrument, the second musical instrument accompaniment is for a second musical instrument, and the first and second musical instruments are different from each other.

14. The method of claim 13, wherein the reference musical instrument performance is by a reference musical instrument, and the reference musical instrument is different from the first and second musical instruments.

15. The method of claim 1, wherein the musical instrument accompaniment data comprises:
dynamic expression information;
temporal information;
timbral information; and/or
spectral expression information.

16. The method of claim 1, wherein generating the musical instrument accompaniment data comprises:
synthesising the first and second musical instrument accompaniments into audible sound,
wherein the musical instrument accompaniment data comprises audio data representing the audible sound.

17. A computer-implemented method, comprising:
obtaining reference musical instrument performance data, the reference musical instrument performance data representing the reference musical instrument performance;
determining one or more musical properties of the reference musical instrument performance based on analysing the reference musical instrument performance data;
generating first musical instrument accompaniment data representing a first musical instrument accompaniment for the reference musical instrument performance, wherein the first musical instrument accompaniment is based on the reference musical instrument performance;
generating second musical instrument accompaniment data representing a second musical instrument accompaniment for the reference musical instrument performance, wherein the second musical instrument accompaniment is based on:
the determined one or more musical properties of the reference musical instrument performance; and
one or more musical properties of the first musical instrument accompaniment; and
outputting the first and second musical instrument accompaniment data.

18. A computer-implemented method of controlling a computing device to generate a musical instrument accompaniment for reference musical instrument performances, the method comprising:
obtaining first reference musical instrument performance data, the first reference musical instrument performance data representing a first reference musical instrument performance;
obtaining second reference musical instrument performance data, the second reference musical instrument performance data representing a second reference musical instrument performance;
generating a musical instrument accompaniment for the first and second reference musical instrument performances, wherein the musical instrument accompaniment is based on the first and second reference musical instrument performances represented by the obtained first and second reference musical instrument performance data; and
outputting musical instrument accompaniment data representing the musical instrument accompaniment.

19. A computing device comprising:
a sensor;
an output component; and
a controller configured to perform the method of claim 1.

20. Non-transitory computer readable medium storing instructions which, when executed by one or more processor, perform the method of claim 1.
